(19) United States
(12) Patent Application Publication
(10) Pub. No.: US 2009/0048381 A1
(43) Pub. Date: Feb. 19, 2009

(54) PROCESS FOR MAKING POLYOLEFIN CLAY NANOCOMPOSITES

(75) Inventor: Eric Vignola, Aliquippa, PA (US)

Correspondence Address: NOVA Chemicals Inc., Westpointe Center, 1550 Coraopolis Heights Road, Moon Township, PA, 15108, US

(73) Assignee: NOVA Chemical Inc., Moon Township, PA (US)

(21) Appl. No.: 11/839,736

(22) Filed: Aug. 16, 2007

(51) Int. Cl. C08K 3/34; C01B 33/26

(52) U.S. Cl. 524/445; 423/328.1

(57) ABSTRACT

A polymerization process to prepare polyolefin-clay nanocomposites from modified clay is described. Polystyrene-clay nanocomposites formed using the inventive method are highly exfoliated and show improved physical properties relative to polystyrene polymers. The process can be applied to bulk or suspension polymerization. The process provided is a two stage polymerization of monomer in the presence of a modified clay. In a first stage, monomer is polymerized within a clay gallery by an intercalated free radical initiator which is activated at a first polymerization temperature. In a second stage, monomer extrinsic to the clay is polymerized using an oil soluble free radical initiator which is activated at a second polymerization temperature.

### FIELD OF THE INVENTION

This invention relates the field of modified clays, polyolefin-clay nanocomposites and to the method of their preparation. A two stage polymerization method is provided in which monomer is first polymerized within a clay gallery using an intercalated free radical initiator at a first polymerization temperature, followed by polymerization of monomer outside a clay gallery using an oil soluble free radical initiator at a second polymerization temperature.

### BACKGROUND TO THE INVENTION

The formation of polyolefin-clay nanocomposites provides new materials having enhanced physical properties. Nanocomposites can be formed in a number of ways which include both in-situ polymerization, where monomer is polymerized in the presence of a clay mineral and post-polymerization methods, where clay materials are melt blended with a polymer. See for example, “Nanocomposites, Polymer-Clay”, by Jean-Marc Lefebvre, Encyclopedia of Polymer Science and Technology, Copyright© 2002 by John Wiley & Sons, Inc., published online: 15 Mar. 2002, pg 336.

Although, the preparation of polymer-clay nanocomposites from polar polymers such as polyamides is relatively straightforward, methods of producing nanocomposites from non-polar polymers, such as polystyrene or polyethylene, are more complicated since non-polar polymers are usually not compatible or miscible with hydrophilic clay materials. This lack of compatibility can lead to poor intercalation of the polymer within the clay gallery. As a result, the clay must be treated with a surface active agent, one which bears a hydrophobic moiety and a hydrophilic moiety. Use of suitable surfactants effectively “masks” the hyrdophilicity of the clay, rendering it compatible with non-polar polymers.

For example, U.S. Pat. No. 4,623,398 describes a method for producing an “organo-clay” by mixing a quaternary ammonium compound with an aqueous suspension of a smectite layered silicate. By subjecting the mixture to high shear conditions, inorganic cations present in the clay are exchanged with the ammonium compounds to give, after simple filtration, a modified clay. The ammonium ion has long chain alkyl substituents which provide the clay with hydrophobic “capping groups”.

The use of mixed organic cations to organically modify a clay is taught in U.S. Pat. No. 5,576,257. Each organic cation is composed of an ammonium or phosphonium salt bearing methyl, benzyl and long chain saturated aliphatic ligands (preferably with 10 to 20 carbons). The clays are not utilized in the formation of nanocomposites, but are used to thicken paint.

U.S. Pat. No. 6,387,996 to AMCOL International, describes a polymer-clay nanocomposite having improved gas permeability and which comprises a layered silicate that has been modified with at least two organic cations or surfactants. By modifying the clay with at least one surfactant of high polarity and one surfactant of low polarity, the inventors were able to control the overall polarity, introduced by the surfactants as a whole, avoiding the need to synthesize a new cationic surfactant with a balance of the desired properties. The organically modified clay served as the basis for improved intercalation and exfoliation within a poly(ethylene-terephthalate)-clay nano-composite after melt blending.

Layered silicates have also been modified by both organic cations and organic anions. In U.S. Pat. No. 4,412,018 to NL Industries, an organically modified clay is produced by admixing an organic anion with clay in water, followed by addition of an organic cation. As a result, an organic cation/organic anion complex became intercalated within the layered silicate. These “organoclays” are utilized as improved gelling reagents. The use of ions having a reactive functional group is not contemplated by the invention.

U.S. Pat. Nos. 6,271,298 and 6,730,719 to Southern Clay Products teach a method of modifying a clay with a negatively charged polyanion. Adding the modified clay to a polymer matrix provides nanocomposites with improved mechanical properties such as improved tensile strength, tensile modulus and flex modulus. Neither patent discusses the use of intercalated free radical initiators to enhance exfoliation of the layered silicate.

European Patent Application 1,193,290 A1 to Sekisui describes an organically modified clay which is suitable for melt blending with a non-polar polymer in the presence of a plasticizer. The organically modified clay results from the treatment of a clay first with a cationic surfactant and then, in a subsequent step, treatment with an anionic chemical substance which contains a reactive functional group. Specifically, the reactive functional group is such that it can react with hydroxyl groups present in the clay gallery. For example, functional groups such as vinyl, silyl, alkoxy, isocyanate, amino and epoxy groups were taught. By interacting with a positively charged crystal side face of the clay (i.e., the clay gallery edges), the anionic chemical substances enhanced the miscibility of a non-polar polymer with the hydrophilic clay structure for the purpose of preparing a nanocomposite material.

In addition to modifying the hydrophobicity of the clay surfaces using standard cationic surfactants, clays have been modified with cationic surfactants bearing reactive functional groups, such as, epoxide groups, or vinylic groups.

For example, U.S. Pat. No. 4,434,075 to NL Industries describes a modified clay, which has been modified by an anionic surfactant and two cationic surfactants. One of the cationic surfactants used has as a substituent and unsaturated alkyl substituent. The modified clays are utilized as gellants.

U.S. Pat. No. 5,429,999 assigned to Rheox Inc discloses organically modified clay which comprises an organic anion and two distinct organic cations. One of the cations used is polyalkoxylated. A similar disclosure is made in European Patent Application 542,266 A2 which provides further examples of organically modified clays which have been ion exchanged with a quaternary ammonium or phosphonium salt, and a polyalkoxylated quaternary ammonium salt.

U.S. Pat. No. 4,718,841, also to Rheox Inc., describes the use of onium cations derived from organic acid esters and optionally organic anions that are capable of reacting with the organic cations to form an organic cation/organic anion ion pair complex. The cation/anion complexes are intercalated within a layered silicate.

U.S. Pat. No. 5,780,376 discloses a process for producing an organically modified clay comprising the reaction product of a smectite clay with a mixture of quaternary ammonium salts, one of which further comprises a reactive carbon-carbon double bond functionality. Optionally, a chain transfer reagent such as a thiol, α-methylketone or a halogen can be added to the clay material. The modified clays provide product improvements to nanocomposites formed by free radical polymerization, particularly to polystyrene or high impact polystyrene nanocomposites.

U.S. Pat. Nos. 5,663,111 and 5,728,764 describe an organically modified clay composition which has been ion exchanged with a quaternary ammonium salt bearing alkoxylated ligands such as ethylene oxide and propylene oxide. The clays of the invention can be used as improved thixotrope Theological reagents.

U.S. Pat. No. 4,810,734 discloses the use of onium ions, bearing pendant unsaturated functional groups, as swelling agents for a clay mineral. The functional groups are capable of reacting and bonding with a polymer and help to disperse a clay mineral in a polyolefin matrix. Examples of the functional groups taught are vinyl, carboxyl, hydroxyl, epoxy and amino groups. The nanocomposites of the invention have a structure in which the layered silicate is ionically bonded to an onium through its positively charged ammonium end, and a polymer is covalently bonded to the onium ion through its functional group end. The nanocomposites taught are nylon-6/clay nanocomposites.

The use of cationic comonomers for preparation of a polystyrene copolymer-clay nanocomposite is the subject of an article by Lee et. al. (Polymer Pre-Prints, vol 43(2), 2002, pg. 1152). An emulsion polymerization process is described in which a clay mineral and a cationic vinyl monomer are combined with styrene to provide a polystyrene copolymer bearing pendant positive charge functionality which helps bind the polystyrene copolymer to the clay mineral. A water soluble cationic initiator, 2,2′azobis(isobutyl-amidine)hydrochloride (AIBA) is added to initiate the polymerization reaction. Wide angle x-ray diffraction (WAXD) experiments demonstrated the importance of the tethered polymer-clay structure to enhancing exfoliation.

The synthesis of a polystyrene-clay nanocomposite by dispersing a clay mineral modified with vinylbenzyl-dimethyldodecylammonium ions in styrene monomer along with an oil soluble initiator, 2,2′azobis(isobutyryl-nitrile) (AIBN) is described by Qutubuddin et. al. in Material Letters vol 42, 2000 pg. 12. The method provided exfoliated polystyrene-clay nanocomposites.

The use of suitably substituted free radical initiators to organically modify a clay material has been described by Sogah et. el. in the Journal of the American Chemical Society (vol 121, 1999, pg 1615). The paper describes the synthesis and use of a silicate-anchored initiator to form a dispersed nanocomposite by in-situ living free radical polymerization. The initiator used was a monocationic, ammonium salt, further functionalized with a nitroxyl linkage in the form of a 2,2,6,6-tetramethylpiper-idine 1-oxyl (TEMPO) group. The cationic free radical initiator enters the clay gallery to facilitate inter-gallery initiation of styrene polymerization. The modified clay is dispersed in bulk monomer and the polymerization effected by raising the temperature to the thermal decomposition temperature of the nitroxyl linkage to generate a free radical initiation site within the clay. As a result, the layers of the layered silicate are pushed apart as polymerization progresses, providing a fully exfoliated polystyrene-clay nanocomposite (i.e., a dispersed clay nanocomposite). This method of forming polymer-clay nanocomposites has been described as surface initiated polymerization (SIP). The disclosure makes no mention of the use of other surfactants to intercalate within the clay or edge treatment of the clay with anionic surfactants.

In U.S. Patent Application Publication No., 2006/0211803, a similar approach is disclosed, but a second surfactant species, a cationic diluent, is added in addition to an activatable cationic surfactant having a nitroxyl linkage. Montmorillonite is first modified with a cationic surfactant bearing pendent unsaturation, and then reacted a nitroxyl source (iBA-DEPN) to give an alkoxyamine group. The alkoxyamine group generates a free radical initiation site on thermal activation. Formation of a polymer nanocomposite follows from heating a dispersion of the modified clay in monomer. There is no teaching of the use of an anionic surfactant to further modify the clay.

In an effort to develop less costly cationic initiators for use with clay minerals, Uthirakumar et. al. in the European Polymer Journal (vol 40, 2004, pg. 2437) disclosed the preparation and use of 2,2-azobis{2-methyl-N-[2-N,N,N-tributylammonium bromide)-ethyl propionamide} (ABTBA), a dicationic azo initiator. The molecule was found to effectively swell a clay mineral, affording a large interlayer spacing when dispersed in non-polar monomers. An ABTBA-montmorillonite clay was used to prepare polystyrene-clay nanocomposites via in-situ intercalative polymerization of styrene. Similar dicationic initiators are described in Colloids and Surfaces A: Physicochem. Eng. Aspects (vol 247, 2004, pg. 69) also by Uthirakumar et. al. In a related European Polymer Journal article (vol 41, 2005, pg. 1582), Uthirakumar et. al disclosed a process for making high impact polystyrene (HIPS)-clay nanocomposites. Montmoril-lonite modified with ABTBA is dispersed in styrene monomer which contains dissolved polybutadiene. Bulk or solution polymerization of the styrene monomer at the thermal activation temperature of the ABTBA free radical initiator gives the desired HIPS-clay nanocomposite. These articles teach nothing about the use of other surfactants to modify the clay gallery or the clay edges in order to improve clay dispersion.

In work carried out by Advincula et. al. in Langmuir, vol 19, 2003, pg 4381, surface initiated polymerization is catalyzed with a mono-cationic azo based free radical initiator similar to those described above. The article provides a comparison between di-cationic and mono-cationic azo based initiators with respect to their exfoliation potential in the formation of polystyrene-clay nanocomposites.

A general discussion on the various methods known to prepare polystyrene-clay nanocomposites, including suspension, emulsion, and bulk polymerization is provided in Chem. Mater., vol 14(9), 2002, pg 3837. A discussion of melt blending methods is also given. Organic modifications made to the clay mineral include the use of a cationic surfactant bearing a styryl monomer. The use of a styryl monomer was found to increase the likelihood of obtaining exfoliated nanocomposites, whereas the use of a surfactant having no polymerizable double bond gave only intercalated nanocomposites. The method of polymerization was found to significantly effect the degree of intercalation vs. exfoliation.

Generally, the use of hyrdophobically modified clays to prepare polyolefin nanocomposites by suspension polymerization is more challenging than bulk polymerization or blending methods, but emulsion processes and suspension have been described.

For example, U.S. Pat. No. 5,883,173 to Exxon Research and Engineering Company discloses the preparation of a latex based on a polymer-clay nanocomposite with reduced permeability to gases. The nanocomposite materials, which comprise a layered silicate intercalated with a non-polar polymer such as polystyrene, also show improved mechanical properties. The latex is formed by dispersing a layered silicate and a surfactant in water, adding a polymerizable monomer and free radical initiator to the dispersion and then inducing the polymerization reaction. Both emulsion and mini-emulsion techniques are disclosed. The surfactants contemplated include quaternary ammonium, phosphonium, maleate, and succinate salts. Surfactants bearing carboxyl groups, acrylate, benzylic hydrogens are also contemplated. The disclosure does not teach the use of mixed anionic/cationic surfactants or the use of a functionalized free radical initiator for the modification of the clay material.

U.S. Pat. No. 5,883,173 also teaches the formation of nanocomposite latexes by emulsion polymerization. Although, the use of surfactants selected from the group consisting of anionic, cationic and nonionic surfactants is contemplated, the disclosure does not teach the use of a free radical initiator bearing a positively charged functional group for modification of a clay material.

U.S. Pat. No. 7,211,613 to Rohm an Haas Company describes an improved method for preparing a polymer clay nanocomposite dispersion. The method involves suspending a “lightly modified” clay in a polymerizable monomer, the combination of which is then dispersed in water to form, after suspension polymerization of the monomer, a polymer-clay nano-composite dispersion. Variations of the invention allow for the formation of polymer clay colloids or hollow polymer clay nanocomposites.

In U.S. Pat. No. 6,759,463 a stepwise version of the above suspension polymerization process is taught. The essential feature of the invention is a pre-polymerization step in which an aqueous suspension of monomer or an aqueous suspension of organically modified clay dispersed in monomer is first polymerized to form a first stage emulsion polymer core particle. This pre-polymerization step is followed by the addition of a second aqueous monomer suspension (i.e., one containing organically modified clay or one without). Polymerization of monomer in the second aqueous suspension forms a second stage emulsion polymer shell around the initially formed polymer core. The invention teaches that the clay can be “lightly modified” by incorporating a polymerizable surfactant (i.e., a surfactant that has a functional group that can be copolymerized with monomer within the reaction mixture). Polar or acid containing monomers are preferred.

Despite the above progress, there remains a need for further improvements in the physical properties of polymer-clay nanocomposites, as well as the methods used to make polymer-clay nanocomposites, especially non-polar polymer-clay nanocomposites.

### SUMMARY OF THE INVENTION

The present invention provides an improved process to make polymer clay nanocomposites from non-polar monomers.

The present invention provides a two stage polymerization process, in which polymerization of monomer is first induced primarily within the clay gallery of a modified clay at a first polymerization temperature (Stage 1). This helps to exfoliate and disperse the clay and can lead to points of attachment between the growing polymer chain and the clay gallery. Stage 1 is followed by polymerization mainly of bulk monomer at a second, higher polymerization temperature, which maintains and enhances exfoliation of the clay gallery, providing a nanocomposite with good mechanical properties (Stage 2).

The present invention provides a polymerization process which is carried out in two stages at two different polymerization temperatures in the presence of a clay which has been modified with a cationic surfactant, a free radical initiator comprising a positively charged functional group and optionally an anionic compound.

In an embodiment of the current invention, polymerization of monomer is initiated first within a modified clay using a cationic free radical initiator which is bound to the clay gallery surfaces and has a relatively low activation temperature (Stage 1). This is followed by initiating polymerization of bulk monomer extrinsic to the clay, by use of an oil soluble free radical initiator, which has a relatively high activation temperature (Stage 2). Further modification of the clay with an anionic compound allows for the two stage process to be carried out using suspension polymerization methods.

The two stage polymerization process provided by the current invention, provides polyolefin clay-nanocomposites which are exfoliated and have improved physical properties.

The current invention provides a polymerization process to prepare a polymer-clay nanocomposite wherein the process comprises: a) dispersing in monomer mixture, a modified clay comprising the reaction product of: i) a clay, ii) a cationic surfactant, and iii) a free radical initiator comprising a positively charged functional group; to give a modified clay/monomer mixture dispersion; b) adding to the modified clay/monomer mixture dispersion, an oil soluble initiator; c) heating the modified clay/monomer mixture dispersion at a first polymerization temperature, wherein the free radical initiator comprising a positively charged functional group is thermally activated; and d) heating the modified clay/monomer mixture dispersion at a second polymerization temperature, wherein the oil soluble free radical initiator is thermally activated; provided that the second polymerization temperature is at least 10° C. higher than the first polymerization temperature.

Polymerization is initiated by heating the modified clay/monomer mixture dispersion to a first polymerization temperature (Stage 1), during which time the free radical comprising a positively charged functional group is thermally activated. The free radical initiator further comprising at least one positively charged functional group has an activation temperature that is at least 10° C. lower than the activation temperature of the oil soluble free radical initiator. The first polymerization temperature can be within about 5° C. of the half-life temperature, T_{1/2} or more than 5° C. above the T_{1/2} of the cationic free radical initiator, provided that the first polymerization temperature does not exceed a temperature that is 10° C. below the T_{1/2} of the oil soluble free radical initiator. Stage 1 is followed by increasing the temperature of the dispersion to a second polymerization temperature (Stage 2) at which the oil soluble free radical initiator is thermally activated. The second polymerization temperature can be within about 5° C. of the T_{1/2} of the oil soluble free radical initiator or more than 5° C. above the T_{1/2} of the oil soluble free radical initiator.

The current invention provides a polymerization process to prepare a polymer-clay nanocomposite wherein the process comprises: a) dispersing in monomer mixture, a modified clay comprising the reaction product of: i) a clay, ii) a cationic surfactant, and iii) a free radical initiator comprising a positively charged functional group; to give a modified clay/-monomer mixture dispersion; b) adding to the modified clay/monomer mixture dispersion, an oil soluble initiator; c) heating the modified clay/monomer mixture dispersion at a first polymerization temperature, which is within about 5° C. of the half-life temperature, T_{1/2} of the cationic free radical initiator, or more than 5° C. above the T_{1/2} of the cationic free radical initiator; and d) heating the modified clay/monomer mixture dispersion at a second polymerization temperature, which is within about 5° C. of the T_{1/2} of the oil soluble free radical initiator or more than 5° C. above the T_{1/2} of the oil soluble free radical initiator; provided that the T_{1/2} of the cationic free radical initiator is at least 10° C. lower than the T_{1/2} of the oil soluble initiator; and provided that the first polymerization temperature does not exceed a temperature that is 10° C. below the T_{1/2} of the oil soluble free radical initiator.

The current invention also provides a polymerization process to prepare a polymer-clay nanocomposite wherein the method comprises: a) dispersing in monomer mixture, a modified clay comprising the reaction product of: i) a clay, ii) a cationic surfactant, iii) a free radical initiator comprising a positively charged functional group and iv) an anionic compound, to give a modified clay/monomer mixture dispersion; b) dispersing the modified clay/monomer mixture dispersion in water to provide an aqueous dispersion; c) adding an oil soluble initiator to the modified clay/monomer mixture dispersion or to the aqueous dispersion; d) optionally adding a stabilizer to the aqueous dispersion; e) heating the aqueous dispersion at a first polymerization temperature, wherein the free radical initiator comprising a positively charged functional group is thermally activated; and f) heating the aqueous dispersion at a second polymerization temperature, wherein the oil soluble free radical initiator is thermally activated; provided that the second polymerization temperature is at least 10° C. higher than the first polymerization temperature.

Polymerization is initiated by heating the aqueous dispersion to a first polymerization temperature (Stage 1), during which time the free radical comprising a positively charged functional group is thermally activated. The free radical initiator further comprising at least one positively charged functional group has an activation temperature that is at least 10° C. lower than the activation temperature of the oil soluble free radical initiator. The first polymerization temperature can be within about 5° C. of the half-life temperature, T_{1/2} of the cationic free radical initiator or more than 5° C. above the T_{1/2} of the cationic free radical initiator, provided that the first polymerization temperature does not exceed a temperature that is 10° C. below the T_{1/2} of the oil soluble free radical initiator. Stage 1 is followed by increasing the temperature of the aqueous dispersion to a second polymerization temperature (Stage 2) at which the oil soluble free radical initiator is thermally activated. The second polymerization temperature can be within about 5° C. of the T_{1/2} of the oil soluble free radical initiator or more than 5° C. above the T_{1/2} of the oil soluble free radical initiator.

The current invention also provides a polymerization process to prepare a polymer-clay nanocomposite wherein the method comprises: a) dispersing in monomer mixture, a modified clay comprising the reaction product of: i) a clay, ii) a cationic surfactant, iii) a free radical initiator comprising a positively charged functional group and iv) an anionic compound, to give a modified clay/monomer mixture dispersion; b) dispersing the modified clay/monomer mixture dispersion in water to provide an aqueous dispersion; c) adding an oil soluble initiator to the modified clay/monomer mixture dispersion or to the aqueous dispersion; d) optionally adding a stabilizer to the aqueous dispersion; e) heating the aqueous dispersion at a first polymerization temperature, which is within about 5° C. of the half-life temperature, T_{1/2} or more than 5° C. above the T_{1/2} of the cationic free radical initiator; and f) heating the aqueous dispersion at a second polymerization temperature, which is within about 5° C. of the T_{1/2} of the oil soluble free radical initiator or more than 5° C. above the T_{1/2} of the oil soluble free radical initiator; provided that the T_{1/2} of the cationic free radical initiator is at least 10° C. lower than the T_{1/2} of the oil soluble initiator; and provided that the first polymerization temperature does not exceed a temperature that is 10° C. below the T_{1/2} of the oil soluble free radical initiator.

In another embodiment of the invention, a polystyrene-clay nanocomposite is provided which is formed according to the above polymerization methods.

The invention also provides a modified clay which is dispersible in an organic or aqueous mixture, the modified clay comprising the reaction product of: a) a clay, b) a cationic surfactant, c) a free radical initiator comprising a positively charged functional group, and d) an anionic compound.

### BRIEF DESCRIPTION OF THE DRAWINGS

FIG. 1 is an X-ray diffraction (XRD) pattern of both a commercially available unmodified clay (CLOISITE®-Na⁺) and a modified clay made according to the present invention.

FIG. 2 is an X-ray diffraction (XRD) pattern of both a commercially available unmodified clay (CLOISITE®-Na⁺) and a modified clay made according to the present invention.

FIG. 3 is an X-ray diffraction (XRD) pattern of both a commercially available unmodified clay (CLOISITE®-Na⁺) and a modified clay made according to the present invention.

FIG. 4 shows an X-ray diffraction (XRD) pattern for a commercially available modified clay (CLOISITE®-10A) and a polystyrene-clay nanocomposite (i.e., PS-modified clay) made from the clay.

FIG. 5 shows an X-ray diffraction (XRD) pattern for a modified clay prepared according to the current invention and a polystyrene-clay nanocomposite made from the clay.

FIG. 6a shows an X-ray diffraction (XRD) pattern for a commercially available modified clay (CLOISITE®-10A) and a polystyrene-clay nanocomposite made from the clay according to the present invention. FIG. 6b shows a Transmission Electron Micrograph (TEM) at two magnifications, of a polystyrene-clay nanocomposite made according to the present invention.

FIG. 7a shows an X-ray diffraction (XRD) pattern for a modified clay made according to the present invention and a polystyrene-clay nanocomposite made from the modified clay according to the present invention. FIG. 7b shows a Transmission Electron Micrograph (TEM) at two magnifications, of a polystyrene-clay nanocomposite made according to the present invention.

FIG. 8a shows an X-ray diffraction (XRD) pattern for a modified clay made according to the present invention and a polystyrene-clay nanocomposite made from the modified clay according to the present invention. FIG. 8b shows a Transmission Electron Micrograph (TEM) of a polystyrene-clay nanocomposite made according to the present invention.

FIG. 9a shows an X-ray diffraction (XRD) pattern for a modified clay and a polystyrene-clay nanocomposite made from the modified clay according to the present invention. FIG. 9b shows a Transmission Electron Micrograph (TEM) of a polystyrene-clay nano-composite made according to the present invention.

FIG. 10a shows an X-ray diffraction (XRD) pattern for a modified clay and a polystyrene/-polybutadiene-clay nanocomposite (i.e. PS-rubber-modified clay) made from the modified clay according to the present invention. FIG. 10b shows a Transmission Electron Micrograph (TEM) of a polystyrene/butadiene-clay nanocomposite made according to the present invention.

FIG. 11a shows an X-ray diffraction (XRD) pattern for a modified clay and a polystyrene-clay nanocomposite made from the modified clay according to the present invention. FIG. 11b shows a Transmission Electron Micrograph (TEM) of a polystyrene-clay nanocomposite made according to the present invention.

### DETAILED DESCRIPTION OF THE INVENTION

The invention provides a polymerization process for the preparation of polymer-clay nanocomposites. The process is a two stage suspension phase or a two stage bulk phase polymerization process. In a first stage, monomer is induced to undergo polymerization primarily within the clay galleries, at a first polymerization temperature, by an intercalated cationic free radical initiator. In a second phase, monomer is induced to undergo polymerization primarily within the bulk monomer, at a second polymerization temperature, by an oil soluble free radical initiator.

In the current invention, the terms “polymer” and “polyolefin” are used interchangeably.

### Clay

In general, “clay” is composed of clay minerals as the main constituent. Clay minerals are composed of layered silicates of nanometer scale thickness. Clay minerals can be amorphous or crystalline, including two and three layer types, mixed layer types and chain structure types as is further described in “Clay Mineralogy”, by Grimm© 1968 by McGraw-Hill, Inc. The crystalline structure of a clay mineral generally comprises layers of silica, SiO₄ tetrahedra that are joined by layers of alumina, AlO(OH)₂ octahedra or magnesia. Hence, clay minerals may also be called “layered silicate” materials. Isomorphic substitution of Al³⁺ or Fe³⁺ for Si⁴⁺ in the silicate layers, and/or substitution of Al³⁺, Fe²⁺ or Mg²⁺ for cations in the octahedral layers results in an excess of negative charge within the layers. Stacking of the silicate layers provides a “clay gallery”, which is represented by a regular interlayer spacing between the layers. The gallery typically contains hydrated inorganic cations, the nature of which is determined by the source of the clay mineral. Calcium, Ca²⁺, sodium, Na⁺ and potassium, K⁺ are common. The thickness of the layers or “platelets” can be of the order of 1 nm or less and aspect ratios are high, typically from 100-1500 (i.e., the clay platelet surfaces have a much larger surface area than the clay platelet edges).

As used herein, the terms “gallery surface” or “basal surface” are used interchangeably and are meant to describe the substantially negatively charged surfaces of the clay platelets. This is contrasted to the terms “clay edges” or “clay gallery edges” which are used herein to describe the positively charged edges of the clay platelets (i.e., the clay crystal edges). The faces of the clay platelets carry a negative charge because of the isomorphic substitutions (e.g., Mg²⁺ for Al³⁺) within the mineral lattice. The edges of the clay platelet can have a slightly positive charge due to layered silicate crystal lattice discontinuities at the edges of the silicate layer (see, for example, European Pat. No. 193,290, which is incorporated herein by reference).

The clay or clay minerals of the current invention are not specifically defined and include any natural or synthetic layered silicate capable of being intercalated or exfoliated. Non-limiting examples of clay minerals that can be used are: smectite, phyllosilicate, montmorillonite, hectorite, betonite, laponite, saponite, beidellite, stevensite, vermiculite, kaolinite, hallosite, and magadiite and mixtures thereof. Of these, montmorillonite (MMT) is preferred.

### Modified Clay

As used herein, the term “modified clay” refers to a clay gallery within which metal cations (such as, but not limited to, Ca⁺, Na⁺, K⁺ and the like) have been exchanged with suitable cationic or dicationic surfactants or positively charged organic compounds.

As used herein, the term “modified clay” also refers to a clay which has been treated with suitable anionic surfactants or negatively charged organic compounds (i.e., anionic compounds).

Anionic compounds can interact with positive charge density present at the clay gallery edges. Generally, the clays used in the current invention will have positively charged clay edges at a pH of less than about 8. Without wishing to be bound by any single theory, anionic exchange can occur by exchange of suitable anionic compounds, such as, but not limited to, surfactants, with hydroxyl groups present at the clay gallery edges; or alternatively, a carboxylic acid can react with hydroxyl groups present at the clay gallery edges to liberate water.

For the purpose of this invention, any chemical reaction or electrostatic interaction of a cationic or anionic compound, with suitable features within the clay gallery, or as a result of ion exchange reactions within the clay gallery, are considered clay modifications. Furthermore, such modifications can take place within the layers of the clay gallery, or at the surface or edge features of the silicate layers.

In general, surfactants or other clay modifying compounds, can have a hydrophilic head group with at least one hydrophobic substituent.

Modification of the clay with surfactants improves compatibility of the clay with non-polar monomers and non-polar polymers and can also help to swell the clay. By “swelling”, it is meant that the surfactants, when intercalated within the clay, expand the clay galleries by increasing the interlayer spacing.

As used herein, the term “intercalated” refers to a situation in which surfactant, monomer or polymer are interposed between the layers of the clay (i.e., are within the clay gallery). Intercalation can increase the interlayer spacing within the clay and is conveniently measured using X-ray diffraction (XRD), a technique well known to those skilled in the art.

The cation exchange capacity of a clay is a measure of the exchangeable cations present in the clay or the total quantity of positive charge that can be absorbed onto the clay. It can be measured in SI units as the positive charge (coulombs) absorbed by the clay per unit of mass of the clay. It is also conveniently measured in milliequivalents per gram of clay (meq/g) or per 100 gram of clay (meq/100 g). 96.5 coulombs per gram of cation exchange capacity is equal to 1 milliequivalent per gram of cation exchange capacity. The methods to measure the CEC of a clay are well known in the art and include, for example, prediction from the clay structural formula or treatment of the clay with alkylammonium ions, as described in “Characterization of Clays by Organic Compounds” by G. Legaly in Clay Minerals 1981, v16, pgs 1-21 which is incorporated herein by reference, and in “Clay Mineralogy”, by Grimm© 1968 by McGraw-Hill, Inc., pgs 224-225. Methods to measure CEC are imprecise and typically provide a range.

In an embodiment of the current invention, the clay can have a cation exchange capacity of at least 50 milliequivalents, per 100 grams on a 100 percent active basis.

### Cationic Surfactants

A cationic surfactant modifies the gallery surfaces by exchanging with one of more inorganic cations present in the clay. Cationic surfactants contain hydrophilic functional groups where the charge of the functional group is positive when dissolved or dispersed in water.

Without wishing to be bound by any single theory, the cationic surfactants, which become intercalated within the clay, also help to exfoliate the clay by increasing the interlayer spacing within the clay gallery.

In the current invention, cationic surfactants include but are not limited to ammonium, phosphonium, sulfonium, pyridinium, and imidazolium compounds and the like or mixtures thereof.

The cationic surfactant preferably contains at least one linear or branched alkyl, aliphatic, aralkyl, alkaryl, or aromatic hydrocarbon group having from 8 to 30 carbon atoms, or alkyl or alkyl-ester groups having from 8 to 30 carbon atoms. The remaining groups of the cationic surfactant can be selected from a group consisting of linear or branched alkyl groups containing from 1 to 30 carbon atoms; aralkyl groups such as benzyl and substituted benzyl moieties including fused ring moieties, having linear chains or branches of from 1 to 22 carbons; alkaryl groups; aryl groups such as phenyl and substituted phenyls including fused ring aromatic groups and substituents; and hydrogen.

In an embodiment of the current invention, the cationic surfactant can be [(R¹)(R²)(R³)(R⁴)N]⁺, [(R¹)(R²)(R³)(R⁴)P]⁺, [(R¹)(R²)(R³)S]⁺ or mixtures thereof, where R¹ is a linear or branched alkyl, aralkyl, alkaryl, or aromatic hydrocarbon group having from 8 to 30 carbon atoms, or alkyl or alkyl-ester groups having from 8 to 30 carbon atoms; and R² to R⁴ are selected from the group consisting of linear or branched alkyl groups containing from 1 to 30 carbon atoms; aralkyl groups such as benzyl and substituted benzyl moieties including fused ring moieties, having linear chains or branches of from 1 to 22 carbons; alkaryl groups; aryl groups such as phenyl and substituted phenyl groups including fused ring aromatic groups and substituents; and hydrogen.

In an embodiment of the current invention, quaternary ammonium or phosphonium surfactants or clay modifying compounds bearing alkyl, aryl, aralkyl or alkaryl groups are used.

Some non-limiting examples of quaternary ammonium compounds for use in the current invention include lauryltrimethylammonium, stearyltrimethylammonium, trioctylammonium, distearyldimethylammonium, distearyldibenzylammonium, cetyltrimethylammonium, benzylhexadecyldimethylammonium, dimethyldi-(hydrogenated tallow) ammonium, and dimethylbenzyl-(hydrogenated tallow)ammonium compounds.

The anionic counterion associated with the cationic surfactant is one that will not adversely affect the clay modification reactions. Some non-limiting examples include halides, sulphates and the like. Hence, the cationic surfactant is generally provided by the addition of a salt of the cationic surfactant.

One or more of the same or different cationic surfactants can be used in the present invention.

### Anionic Compounds

The anionic compounds used in the current invention bear an anionic group having a strong affinity for interaction with the edges of the clay gallery. Preferably, the edges of the clay gallery will have some positive charge density which can interact with the anionic compounds.

Anionic compounds can be anionic surfactants which are compounds having a hydrophilic functional group in a negatively charged state in an aqueous solution. Without wishing to be bound by any single theory, anionic surfactants can modify the gallery edges by exchanging with one of more anions at or near the clay gallery edges. Alternatively, the anionic compound of the current invention can be added in acid form instead of salt form. Preferred acids will have a pK_{A} of less than about 11, so that they are ionizable under the conditions used in the current invention.

The anionic compounds used in the current invention can be reactive (i.e., they have moieties which react with functional groups present in the clay) or non-reactive (i.e., they form conventional electrostatic interactions with the clay). Compounds capable of generating an anionic site within their molecular structure on exposure to a clay material are also contemplated for use with the current invention.

Anionic compounds that are useful in the current invention include, but are not limited to surfactant salts or acids of: carboxylates (such as lauryl, stearyl, oleyl and cetyl carboxylates); sulfates (such as alkyl ether sulfates, alkyl ester sulfates and alkyl benzene sulfates); sulfonates (such as alkylbenzene sulfonate, alkylnaphthalene sulfonate, and paraffin sulfonate); phosphonates; phosphates (such as alkyl ether phosphates or alkyl ester phosphates and polyphosphates); phenolates; cyanates; thiocyanates and mixtures thereof.

In an embodiment of the current invention, the anionic compounds are surfactant salts or acids of: carboxylates, (R⁵)COO⁻; phosphates, (R⁵)OPO(OH)O⁻; sulfates, (R⁵)OSO₃⁻; sulfonates, (R⁵)SO₃⁻and mixtures thereof. In an aspect of the invention, R⁵ is selected from the group consisting of linear or branched alkyl groups having from 8 to 30 carbon atoms; aralkyl groups which are substituted benzyl moieties including fused ring moieties, having linear chains or branches of from 3 to 22 carbons; alkaryl or substituted aryl groups having linear chains or branches of from 3 to 22 carbons.

In another embodiment, polyelectrolytes or anionic polymers such as but not limited to polyacrylate can be used to treat the clay edges.

One or more of the same or different anionic compounds can be used in the present invention.

The cationic counterion associated with the use of an anionic surfactant is one that will not adversely affect the clay modification reactions. Non-limiting examples of cationic counterions include alkali metals and ammonia cations.

In an embodiment of the current invention, the anionic compound is a surfactant salt, such as but not limited to sodium dodecylbenzenesulfonate, sodium dodecyl sulfate or mixtures thereof.

### Free Radical Initiator Comprising a Positively Charged Functional Group

As used herein, the term “free radical initiator” refers to a substance that on exposure to energy or radiation decomposes to liberate free radicals. In a preferred embodiment of the current invention, the free radical initiator comprising a positively charged functional group decomposes in response to thermal energy.

In the current invention, the term “cationic free radical initiator” can be used interchangeably with the term “free radical initiator comprising a positively charged functional group”. The terms “free radical initiator comprising a positively charged functional group” and “cationic free radical initiator” are meant to include free radical initiator compounds having one or more than one positively charged functional group. The terms “thermal activation temperature and “activation temperature” are used interchangeably in the current invention.

The current invention contemplates the use of any one of a number of available free radical initiators further comprising at least one positively charged functional group, provided that they have an activation temperature that is at least 10° C. lower than the activation temperature of the oil soluble free radical initiator.

The thermal activation temperature of the cationic free radical initiator is herein represented by the half-life temperature, T_{1/2} of the free radical initiator for a given time period. The half-life temperature T_{1/2} is the temperature at which half of the initial concentration of a free radical source (i.e., a free radical initiator) is converted to its corresponding free radical within a designated time period. Time periods of 1 min, 1 hr or 10 hr are typically used to measure the T_{1/2} of free radical initiators.

It is understood by a person skilled in the art, that the conditions used (especially the solvents used) for the determination of the half-life temperature of a given free radical initiator can affect the measured T_{1/2} value. For example, the cationic free radical initiator half-life temperature is typically determined in water, but alcohols can also be used. In contrast, the oil soluble free radical initiators are typically dissolved in organic solvents to determine the half-life temperature.

For the current invention, the solvent used to determine the half life temperature of the oil soluble free radical initiator is an organic solvent such as but not limited to benzene, toluene, acetone, decane, dodecane, dichloromethane and trichloroethylene. The solvent used to determine the half life temperature of the cationic free radical initiator is selected from water or alcohols.

The period in time for the T_{1/2} value (1 min, 1 h, or 10 h) is not especially important, as long as the period applied is the same for both the cationic free radical initiator and the oil soluble free radical initiator, when considering the difference in their thermal activation temperatures.

In an embodiment of the current invention, the half-life temperature, T_{1/2} in 1 hr (as determined in water), of the free radical initiator comprising a positively charged functional group, is at least 10° C. lower than the half-life temperature, T_{1/2} in 1 hr (as determined in an organic solvent), of the oil soluble free radical initiator.

In another embodiment of the current invention, the half-life temperature, T_{1/2} in 1 hr (as determined in water), of the free radical initiator comprising a positively charged functional group, is at least 20° C. lower than the half-life temperature, T_{1/2} in 1 hr (as determined in organic solvent), of the oil soluble free radical initiator.

In the current invention, it is preferred that the free radical initiator comprising a positively charged functional group will have a T_{1/2} in 1 hr (as determined in water), that is lower than the thermally induced polymerization temperature of the monomer (i.e., the temperature at which the majority of monomer polymerizes in the absence of an activator).

The free radical initiator comprising a positively charged functional group can be an azo compound, a peroxide compound or a compound having a nitroxyl linkage, such as compounds having the 2,2,6,6-tetramethylpiperidine-N-oxyl (TEMPO) moiety.

The type of positively charged functional group (or groups) is not especially important, provided that it is capable of exchanging with cations within the clay gallery. For example, the positively charged functional group can be selected from the group consisting of quaternary ammonium ions, phosphonium ions, sulfonium ions, pyridinium ions, imidazolium, amidinium ions and guanidinium ions. One or more cationic functional groups can be present in the cationic free radical initiator.

In an aspect of the invention, the free radical initiator site, defined as the bond which breaks to generate free radicals on exposure to thermal radiation, and the positively charged functional group, B⁺ are separated by at least a two atom spacer group Aₙ, where n is 2 or more, according to formula I (for an N═N, azo based free radical initiator), II (for a O—O, peroxide based free radical initiator), and III (for a N—O, nitroxyl based free radical initiator):

—N═N-(A)ₙ-B⁺ I

—O—O-(A)ₙ-B⁺ II

(—)₂N—O-(A)ₙ-B⁺ III

In an embodiment of the current invention, the free radical initiator comprising a positively charged functional group is selected from the group consisting of: 2,2′-azobis[2-(5-methyl-2-imidazolin-2-yl)propane]-dihydrochloride (T_{1/2} 10 hr=41° C. in water); 2,2′-azobis[2-(2-imidazolin-2-yl) propane]dihydrochloride (T_{1/2} 10 hr=44° C. in water); 2,2′-azobis[2-(2-imidazo-lin-2-yl)propane]disulfate dehydrate (T_{1/2} 10 hr=47° C. in water); 2,2′-azobis(2-methylpropionamidine)dihydrochloride (T_{1/2} 1 hr=74° C. and T_{1/2} 10 hr=56° C. in water); 2,2′-azobis[2-(3,4,5,6-tetrahydropyrimidin-2-yl)propane]dihydrochloride (T_{1/2} 10 hr=58° C. in water); azobis{2-[1-(2-hydroxyethyl)-2-imidazolin-2-yl]propane}dihydrochloride (T_{1/2} 10 hr=60° C. in water); 2,2′-Azobis(1-imino-1-pyrrolidino-2-ethylpropane)dihydrochloride (T_{1/2} 10 hr=67° C. in water) and combinations thereof. The use of other free radical initiators comprising a positively charged functional group known in the art is also contemplated by the current invention.

Without wishing to be bound by any single theory, exchange of the cations initially present within a clay material, with free radical initiators comprising a positively charged functional group, will provide a modified clay, which has a free radical initiator source bound to the surface of the clay gallery by an ionic interaction. Thus, use of a free radical initiator comprising a positively charged functional group can after thermal activation to promote polymerization, generate one or more points of attachment between the resulting polyolefin and the modified clay.

The use of more than one type of cationic free radical initiator is also contemplated by the present invention, provided that the T_{1/2} of each of the cationic free radical initiators is at least 10° C. lower than the half-life temperature, T_{1/2} of each oil soluble free radical initiator.

### Oil Soluble Free Radical Initiator

The current invention contemplates the use of any one of a number of available free radical initiators, provided that they are soluble in monomer or a monomer mixture and have an activation temperature that is at least 10° C. higher than the activation temperature of the free radical initiator comprising a positively charged functional group.

As used herein, the term “oil soluble” connotes solubility in the monomer or monomer mixture containing the monomer that is to be polymerized.

The thermal activation temperature of the oil soluble free radical initiator is herein represented by the half-life temperature, T_{1/2} of the free radical initiator for a given time period.

In an embodiment of the current invention, the half-life temperature, T_{1/2} in 1 hr (as determined in an organic solvent), of the oil soluble free radical initiator is at least 10° C. higher than the half-life temperature, T_{1/2} in 1 hr (as determined in water), of the free radical initiator comprising a positively charged functional group.

In another embodiment of the current invention, the half-life temperature, T_{1/2} in 1 hr (as determined in an organic solvent), of the oil soluble free radical initiator is at least 20° C. higher than the half-life temperature, T_{1/2} in 1 hr (as determined in water), of the free radical initiator comprising a positively charged functional group.

Oil soluble initiators that can be used with the current invention include but are not limited to peroxides and hydroperoxides, azo compounds, and photoinitiators. In an aspect of the invention, the oil soluble initiators are organic peroxides or azo compounds.

In one embodiment of the current invention, organic peroxides can be used such as ketone peroxides, peroxyketals, hydroperoxides, dialkyl peroxides, diacyl peroxides, peroxydicarbonates, peroxyesters, and the like.

Some specific non-limiting examples of organic peroxides that can be used as the oil soluble initiator include: lauroyl peroxide, 1,1-bis(t-hexylperoxy)-3,3,5-trimethylcyclohexane, 1,1-bis(t-butylperoxy)-3,3,5-trimethylcyclohexane, t-butylperoxylaurate, t-butylperoxyisopropylmonocarbonate, t-butylperoxy-2-ethylhexylcarbonate, di-t-butylperoxyhexahydro-terephthalate, dicumyl peroxide, 2,5-dimethyl-2,5-di(t-butylperoxy)hexane, di-t-butyl peroxide, t-butylperoxy-2-ethylhexanoate, bis(4-t-butylcyclohexyl)peroxydi-carbonate, t-amylperoxy-3,5,5-trimethylhexanoate, 1,1-di(t-amylperoxy)-3,3,5-trimethylcyclohexane, benzoyl-peroxide, t-butylperoxyacetate, and the like. In an embodiment of the current invention t-butylperoxy-acetate is used as the organic peroxide.

Some specific non-limiting examples of azo compounds that can be used as the oil soluble initiator include: 2,2′-azobis-isobutyronitrile, 2,2′-azobis-2,4-dimethylvaleronitrile, 1,1′-azobis-1-cyclohexane-carbonitrile, dimethyl-2,2′-azobisisobutyrate, 1,1′-azobis-(1-acetoxy-1-phenylethane), and the like.

The use of more than one type of oil soluble initiator is also contemplated by the present invention, provided that the T_{1/2} of each of the oil soluble initiators is at least 10° C. higher than the half-life temperature, T_{1/2} of each cationic free radical initiator.

### Preparing the Modified Clay

The modified clay is prepared by adding a cationic surfactant, a free radical initiator comprising a positively charged functional group and optionally an anionic compound to an aqueous dispersion of unmodified clay under agitation. The cationic surfactant, the free radical initiator comprising a positively charged functional group and the anionic compound can be conveniently added in the form of a solution or a slurry.

The clay is dispersed in water at a concentration of from about 1% to 80%, preferably from about 1% to 15% by weight.

The dispersion can be stirred at from about 0° C. to 150° C., preferably between from about 30° C. to 90° C. for a period of time that is sufficient for the surfactants and cationic free radical initiator to react with the clay. Various agitation methods are contemplated for use with the current invention. For example, stirring methods such as magnetic stirring, mechanical stirring, and high shear mixing or combinations thereof can be to provide ultrasonic mixing. The clay can be isolated by, for example, centrifugation or filtration. The isolated clay can optionally be washed with water, dried, ground and sieved.

In an embodiment of the invention, the clay is washed with water to remove excess surfactant, dried, and ground (by, for example, ball-milling), and then sieved to particle sizes below about 20 microns.

The amount of cationic surfactant and cationic free radical initiator used in the current invention depends on the type of clay material, however, in general, the total amount of cationic surfactant and free radical initiator comprising a positively charged functional group (i.e., cationic surfactants+cationic free radicals initiators) can be loaded at between 25% and 1000% of the cationic exchange capacity of the clay. In one embodiment of the current invention, the total amount of cationic surfactant and free radical initiator comprising a positively charged functional group can be loaded at between 100% and 300% of the cationic exchange capacity of the clay. In another embodiment of the current invention, the total amount of cationic surfactant and free radical initiator comprising a positively charged functional group can be loaded at between 50% and 150% of the cationic exchange capacity of the clay.

The amount of anionic compound added is preferably sufficient to neutralize the clay edges. For purposes of the current invention, the clay edges are neutralized when the clay does not destabilize a suspension of the clay and monomer in water.

The ratio of cationic surfactant to cationic free radical initiator can be from 99:1 to 1:99 mol %. In a preferred embodiment of the current invention, the ratio of cationic surfactant to cationic free radical initiator is from 95:5 to 50:50 mol %.

Without wishing to be bound by any single theory, addition of a cationic surfactant leads to intercalation of the cationic surfactant within the clay gallery, which increases the interplanar spacing and swells the clay.

The molar ratio of anionic compound to the total amount of cationic surfactant and free radical initiator comprising a positively charged functional group (i.e., cationic surfactant+cationic free radical initiator) can be from 1:100 to 1:2. In another aspect of the current invention, the ratio can be from 1:75 to 1:10.

In an embodiment of the current invention, the unmodified clay is dispersed in water, followed by the simultaneous addition of a free radical initiator comprising a positively charged functional group and a cationic surfactant.

In another embodiment of the invention, the unmodified clay is dispersed in water, followed by a solution of a free radical initiator comprising a positively charged functional group and a cationic surfactant in water. The cationic surfactant can be fully loaded or partially loaded with the free radical initiator comprising a positively charged functional group. If the cationic surfactant is only partially loaded, then the full complement of the cationic surfactant can be added in a subsequent addition step.

The free radical initiator comprising a positively charged functional group and the cationic surfactant can also be added to the clay sequentially in any order.

In another embodiment of the current invention, an anionic compound is added first to the dispersion of unmodified clay in water, followed by the simultaneous addition of a free radical initiator comprising a positively charged functional group and a cationic surfactant.

In another embodiment of the invention, an anionic compound is added first to the dispersion of unmodified clay in water, followed by the sequential addition of a free radical initiator comprising a positively charged functional group and then a cationic surfactant.

In yet another embodiment of the invention, an anionic compound is added first to the dispersion of the unmodified clay in water, followed by a solution of a free radical initiator comprising a positively charged functional group and a cationic surfactant in water. The cationic surfactant can be fully loaded or partially loaded with the free radical initiator comprising a positively charged functional group. If the cationic surfactant is only partially loaded, then the full complement of the cationic surfactant can be added in a subsequent addition step.

The free radical initiator comprising a positively charged functional group and the cationic surfactant can also be added to the clay sequentially in any order after the addition of the anionic compound.

Without wishing to be bound by any single theory, anionic compounds interact with the positive charge density at the clay gallery edges.

The above describes various embodiments of the invention and is not meant to be limiting. As an example of a non-limiting example, a cationic surfactant and/or a free radical initiator comprising a positively charged functional group can be added to an unmodified clay before addition of an anionic compound. However, this can require additional washing or rinsing steps as well as additional anionic compound to ensure interaction of the anionic compound with the clay gallery edges.

### Bulk Polymerization at Two Temperatures

In an embodiment of the current invention, a modified clay, which is the reaction product of a clay, a cationic surfactant and a free radical initiator comprising a positively charged functional group, with or without the addition of an anionic compound, is dispersed in monomer mixture. Various agitation methods including high shearing methods can be used to disperse the clay in bulk monomer.

In an embodiment of the invention, the modified clay is dispersed in monomer mixture by stirring at more than about 0° C. to prepare a modified clay/monomer mixture dispersion. Without wishing to be bound by any single theory, by stirring the modified clay in monomer mixture, the monomer mixture is intercalated within the clay gallery, and can cause the clay to swell.

The loading of the modified clay in monomer mixture can be from 0.1 weight percent (wt %) to about 10 wt %, provided that the viscosity of the dispersion does not prevent uniform agitation.

In an embodiment of the invention, a second free radical initiator which is oil soluble and has an activation temperature that is at least 10° C. higher than the activation temperature of the cationic free radical initiator, is added to the dispersion. The oil soluble initiator can be added at any time during the preparation of the dispersion. In an embodiment of the invention, the oil soluble initiator is added after the dispersion has been stirred. The oil soluble initiators can be added in a range of from 50 ppm to 10000 ppm.

In an embodiment of the invention, polymerization is initiated by heating the dispersion to a first polymerization temperature (Stage 1), during which time the free radical comprising a positively charged functional group is thermally activated. The first polymerization temperature is within 5° C. of the T_{1/2} in 1 hr or more than 5° C. above the T_{1/2} in 1 hr, of the cationic free radical initiator, provided that the first polymerization temperature does not exceed a temperature that is 10° C. below the T_{1/2} in 1 hr, of the oil soluble free radical initiator. Stage 1 is followed by increasing the temperature of the dispersion to a second polymerization temperature (Stage 2) at which the oil soluble free radical initiator is thermally activated. The second polymerization temperature is within 5° C. of the T_{1/2} in 1 hr of the oil soluble free radical initiator or more than 5° C. above the T_{1/2} in 1 hr, of the oil soluble free radical initiator.

In an embodiment of the invention, the second polymerization temperature will be at least 10° C. higher than the first polymerization temperature.

In an embodiment of the invention, polymerization is initiated by heating the dispersion to a first polymerization temperature (Stage 1) for at least 1 hr, during which time the free radical comprising a positively charged functional group is thermally activated.

Without wishing to be bound by any single theory, the two stage polymerization process (i.e., bulk polymerization at two temperatures), first induces polymerization of monomer (and optional comonomer) primarily within the clay gallery and without significant extra-gallery polymerization (Stage 1). This helps to exfoliate and disperse the clay and can lead to points of attachment between the growing polymer chain and the clay gallery. This is followed by polymerization mainly of bulk monomer (and optional comonomer) which maintains and enhances exfoliation of the clay gallery, providing a nanocomposite with good mechanical properties (Stage 2).

The current invention provides for expansion of the layers within a clay gallery under thermodynamically favorable conditions, as the surrounding monomer mixture medium is of lower viscosity than the monomer mixture within the modified clay gallery. This contrasts with methods which polymerize monomer simultaneously within the clay galleries and externally to the clay, which can prevent expansion of the clay gallery structure due to the increasing viscosity of the surrounding medium.

### Suspension Polymerization

“Suspension polymerization” generally refers to a polymerization process in which the monomer or monomer mixture is substantially immiscible with water. Monomer mixture is kept in suspension using continuous agitation and optionally one or more stabilizers. The resultant monomers (and optional comonomers) in the monomer mixture droplets are polymerized using oil soluble (i.e., monomer mixture soluble) initiators.

Stabilizers for suspension polymerization are well known to those skilled in the art and can include water soluble stabilizers such as poly(vinyl)alcohol, methylcellulose, gelatin and alkali salts of poly(methacrylic acid). For further examples or suspension stabilizers see U.S. Pat. No. 4,583,859. The stabilizers are present in from 0.01 to 10 wt %, preferably from 0.01 to 2 wt %. optionally, salts can be added to reduce the solubility of the monomer mixture in water.

In an embodiment of the current invention, a modified clay, which is the reaction product of a clay, a cationic surfactant and an anionic compound, is dispersed in monomer mixture. Various agitation methods including high shearing methods can be used to disperse the clay in bulk monomer mixture. Without wishing to be bound by any single theory, by stirring the modified clay in monomer mixture, the monomers (and optional comonomers and/or dissolved polymers) are intercalated within the clay gallery, and can cause the clay to swell. The modified clay/monomer mixture dispersion is then added to water to prepare an aqueous dispersion. An oil soluble free radical initiator is added to either the modified clay/monomer mixture dispersion or to the aqueous dispersion, and polymerization is initiated by increasing the temperature of the aqueous dispersion to a temperature at which the oil soluble free radical initiator is thermally activated. The temperature at which the oil soluble free radical initiator is activated is generally within about 5° C. of the T_{1/2} in 1 hr of the oil soluble free radical initiator or more than 5° C. above the T_{1/2} in 1 hr, of the oil soluble free radical initiator, although lower temperatures may also be used.

In a preferred embodiment of the current invention, a modified clay, which is the reaction product of a clay, a cationic surfactant, a free radical initiator comprising a positively charged functional group, and an anionic compound, is dispersed in monomer mixture. Various agitation methods, including high shearing methods, can be used to disperse the clay in bulk monomer mixture. Without wishing to be bound by any single theory, by stirring the modified clay in monomer mixture, the monomers (and optional comonomers and/or dissolved polymers) are intercalated within the clay gallery, and can cause the clay to swell. The modified clay/monomer mixture dispersion is then added to water to prepare an aqueous dispersion.

In an embodiment of the invention, a second free radical initiator, which is oil soluble and has a thermal activation temperature that is at least 10° C. higher than the thermal activation temperature of the cationic free radical initiator, is added to either the modified clay/monomer mixture dispersion or to the aqueous dispersion. The oil soluble initiator can be added at any time during the preparation of either dispersion. In one embodiment, the oil soluble initiator is added after the modified clay/monomer mixture dispersion has been stirred. In another embodiment, the oil soluble initiator is added after the aqueous dispersion has been stirred. The oil soluble initiators can be added in 100 to 10,000 parts per million (ppm). The clay loading in the dispersions can be from 0.1 to 10 wt %.

In an embodiment of the invention, polymerization is initiated by heating the aqueous dispersion to a first polymerization temperature (Stage 1), during which time the free radical comprising a positively charged functional group is thermally activated. The first polymerization temperature is within 5° C. of the T_{1/2} in 1 hr or more than 5° C. above the T_{1/2} in 1 hr, of the cationic free radical initiator, provided that the first polymerization temperature does not exceed a temperature that is 10° C. below the T_{1/2} in 1 hr, of the oil soluble free radical initiator. Stage 1 is followed by increasing the temperature of the aqueous dispersion to a second polymerization temperature (Stage 2) at which the oil soluble free radical initiator is thermally activated. The second polymerization temperature is within 5° C. of the T_{1/2} in 1 hr of the oil soluble free radical initiator or more than 5° C. above the T_{1/2} in 1 hr, of the oil soluble free radical initiator. The aqueous dispersion can be stirred for at least 1 hr at a second polymerization temperature.

In an embodiment of the invention, the second polymerization temperature will be at least 10° C. higher than the first polymerization temperature.

In an embodiment of the invention, polymerization is initiated by heating the aqueous dispersion to a first polymerization temperature (Stage 1) for at least 1 hr, during which time the free radical comprising a positively charged functional group is thermally activated.

Without wishing to be bound by any single theory, the two stage polymerization process (i.e., suspension polymerization at two temperatures), first induces polymerization of monomer (and optional comonomer) primarily within the clay gallery and without significant extra-gallery polymerization (Stage 1). This helps to exfoliate and disperse the clay and can lead to points of attachment between the growing polymer chain and the clay gallery. This is followed by polymerization mainly of suspended bulk monomer (and optional comonomer) which maintains and enhances exfoliation of the clay gallery, providing a nanocomposite with good mechanical properties.

### Monomer Mixture

The current invention can be used with one or more of any non-polar, free radical polymerizable monomer or monomer mixture.

In an embodiment of the invention, the monomer mixture comprises one or more aryl monomers. As used herein, the term “aryl monomers” refers to molecules that contain a non-aromatic unsaturated hydrocarbon group containing from 2 to 12 carbon atoms and a group obtained by removing a hydrogen atom from an aromatic compound that contains from 6 to 24 carbon atoms. Some non-limiting examples of aryl monomers include styrene, methylstyrene (i.e., p-methylstyrene and α-methyl-styrene), tertbutylstyrene, dimethyl-styrene and mixtures thereof.

In another embodiment of the current invention, the monomer mixture further comprises one or more than one comonomer.

Some non-limiting examples of comonomers that can be used in the current invention include butadiene, isoprene, chloroprene, acrylic acid, vinyl acetate, vinyl chloride, acrylonitrile, methacrylonitrile, methyl methacrylate, methyl acrylate, ethyl acrylate, n-propyl acrylate, iso-propyl acrylate, n-butyl acrylate, iso-butyl acrylate, t-butyl acrylate, ethyl methacrylate, n-propyl methacrylate, iso-propyl methacrylate, n-butyl methacrylate, iso-butyl methacrylate, t-butyl methacrylate, maleic anhydride, hydroxyethyl acrylate, hydroxyethyl methacrylate, hydroxypropyl acrylate, hydroxypropyl (meth)acrylate acrylamide, methacrylamide, vinyl propionate, vinyl butyrate, vinyl stearate, isobutoxymethyl acrylamide, and methacrylic acid

In another embodiment of the current invention, the monomer mixture contains one or more than one dissolved polymer or copolymer.

The polymer or copolymer can be selected from a wide range of polymers including elastomeric polymers and thermoplastic polymers provided that the polymer or copolymer is soluble in monomer mixture.

Suitable elastomeric polymers include homopolymers of butadiene, or isoprene, and random, block, AB diblock, or ABA triblock copolymers of a conjugated diene with an aryl monomer and/or acrylonitrile and/or (meth)acrylonitrile, and random, alternating or block copolymers of ethylene and vinyl acetate, and combinations thereof.

As used herein, the term “conjugated diene” refers to a linear, branched or cyclic hydrocarbon containing from 4 to 32 carbon atoms, and optionally hetero atoms selected from O, S, or N, which contain two double bonds separated by one single bond in a structure where the two double bonds are not part of an aromatic group.

In an embodiment of the invention, the elastomeric polymers include one or more block copolymers selected from diblock and triblock copolymers of styrene-butadiene, styrene-butadiene-styrene, styrene-isoprene, styrene-isoprene-styrene, partially hydrogenated styrene-isoprene-styrene, ethylene-vinylacetate and combinations thereof.

In another embodiment of the invention, suitable elastomeric polymers include copolymers of one or more conjugated dienes such as but not limited to butadiene, isoprene (i.e., 2-methyl-1,3-butadiene), 3-butadiene, 2,3-dimethyl-1,3-butadiene and 1,3-pentadiene, one or more of a suitable unsaturated nitrile, such as, acrylonitrile or methacrylonitiles and, optionally, one or more of a polar monomer mixture such as acrylic acid, methacrylic acid, itaconic acid and maleic acid, alkyl esters of unsaturated carboxylic acids, such as, methyl acrylate and butyl acrylate; alkoxyalkyl esters of unsaturated carboxylic acids, such as, methoxy acrylate, ethoxyethyl acrylate, methoxyethyl acrylate, acrylamide, methacrylamide; N-substituted acrylamides, such as, N-methylolacrylamide, N,N′-dimethylolacrylamide and N-ethoxymethylolacrylamide; N-substituted methacrylamides, such as, N-methylolmeth-acrylamide, N,N′-dimethylolmethacrylamide, N-ethoxymethylmethacrylamide and vinyl chloride. Other suitable monomer mixtures include aromatic vinyl monomer mixtures, such as, but, not limited to, styrene, o-, m-, p-methyl styrene, and ethyl styrene. These types of copolymers are known as “acrylonitrile-butadiene rubbers” or “acrylonitrile-butadiene-styrene rubbers” or collectively as “nitrile rubbers” by those skilled in the art. The nitrile rubbers can be partially hydrogenated in the presence of hydrogen, optionally with a suitable hydrogenation catalyst.

Suitable non-elastomeric (i.e., thermoplastic) polymers include polystyrene, polyethylene, polypropylene and copolymers made from ethylene, propylene and/or styrene. Other suitable polymers include polyphenylene ether and polyphenylene ether/polystyrene mixtures.

### Nanocomposites

In the current invention, the polymer-clay nanocomposite can have partially or completely exfoliated (i.e., dispersed) clay. As used herein, the term “partially exfoliated” means that the layers of the clay have been partially separated from one another (i.e., that some layers have been separated from one another, while others have not). The terms “exfoliated” or “dispersed” refer to clay materials in which the layers of the clay have been completely separated from one another. The degree of exfoliation can be examined using TEM and XRD techniques, which are well known in the art. Greater exfoliation of the clay is preferred for improved physical properties of the nanocomposite, particularly barrier properties.

In an embodiment of the current invention, the polymer-clay nanocomposites can comprise polystyrene (PS), rubber modified “High Impact Polystyrene” copolymers (HIPS) or rubber modified copolymers of styrene, acrylonitrile-butadiene-styrene copolymers (ABS), styrene-maleic anhydride (SMA), polyethylene-styrene interpolymers, or styrene-acrylonitrile copolymers (SAN) and can optionally also comprise acrylic vinyl copolymers.

The polymer-clay nanocomposites can also comprise copolymers resulting from the copolymerization of styrene, methylstyrene and/or dimethylstyrene with at least one polymerizable comonomer mixture selected from the group consisting of butadiene, isoprene, chloroprene, acrylonitrile, methacrylonitrile, methyl methacrylate, methyl acrylate, ethyl acrylate, n-propyl acrylate, iso-propyl acrylate, n-butyl acrylate, iso-butyl acrylate, t-butyl acrylate, ethyl methacrylate, n-propyl methacrylate, iso-propyl methacrylate, n-butyl methacrylate, iso-butyl methacrylate, t-butyl methacrylate, maleic anhydride, hydroxyethyl acrylate, hydroxyethyl methacrylate, hydroxypropyl acrylate, hydroxypropyl (meth)acrylate acrylamide, methacryl-amide, vinyl propionate, vinyl butyrate, vinyl stearate, isobutoxymethyl acrylamide, and methacrylic acid.

Typical clay concentration ranges in the nanocomposites formed using the current invention can be from about 0.1 to 20 wt %.

The nanocomposites of the current invention can also include one or more additives selected from anti-static agents, flame retardants, pigments or dyes, lubricants, fillers, stabilizers (UV and/or heat and light), coating agents, plasticizers, chain transfer agents, crosslinking agents, nucleating agents, and insecticides and/or rodenticides. Additives can be added at any point during or after the polymerization processes of the current invention so that they are incorporated into the polymer-clay nanocomposites.

In addition to the inventive methods described above, it is recognized that the polymer-clay nanocomposites of the current invention can also be prepared by high temperature extrusion blending of the modified clay with a polyolefin, the methods of which are well known in the art.

The invention is further illustrated by the following non-limiting examples.

### EXAMPLES

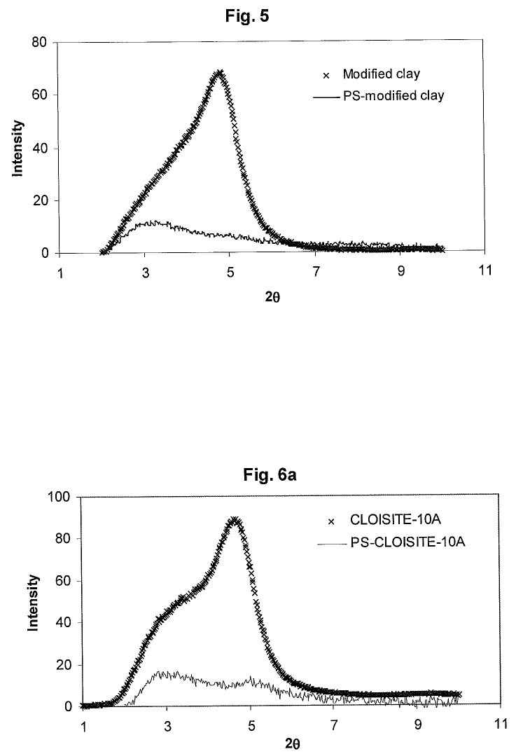

X-ray diffraction (XRD) analysis was conducted on a Siemens General Area Detector Diffraction System using a Kristalloflex 760 X-ray generator with a power setting of 40 kV/40 mA and a 0.5 mm collimator. Each nanocomposite blend was pressed into a 40 mm by 10 mm plaque measuring 1 mm in thickness using a Wabash-Genesis series compression molding press, according to ASTM D4703-03 density plaque conditions. All were run at a distance of 30.00 cm from the detector, where a total run collection consisted of 5×10⁶ counts at a 0.154 nm wavelength (CuKα). FIGS. 5, 6a, 7a, 8a, 9a, 10a and 11a show the XRD patterns obtained after subtracting the polymer background from the polymer-clay nanocomposite samples.

The morphology of the nanocomposites was examined by use of a transmission electron microscopy (TEM). This investigation was performed on a Hitachi H7000 unit operated at an acceleration voltage of 75 kV. Samples were mounted on Epon blocks and ultramicrotomed using a diamond knife.

The T_{1/2} values (in 1 hr or 10 hr) for the free radical initiators comprising a positively charged functional group as well as for the oil soluble initiators are readily available from commercial suppliers. Alternatively, the T_{1/2} values (in 1 min, 1 hr or 10 hr) can be determined using techniques well known in the art.

### Modified Clay

### Examples 1(a)-1(h)

In general, CLOISITE®-Na⁺ (CLOISITE®-Na⁺ is an unmodified natural montmorillonite clay available from Southern Clay Products) was modified with a cationic surfactant and a free radical initiator comprising a positively charged functional group by simultaneous or sequential addition of the modifiers. The cationic surfactant and the cationic free radical were added at a temperature of between 0° C. and 5° C. to prevent the free radical initiator from comprising a positively charged functional group from decomposing or reacting. Small-scale clay modifications were based on 1.5 g of unmodified clay. A 500 ml glass beaker was used to hold 150 g of distilled water which was stirred with an overhead stirrer.

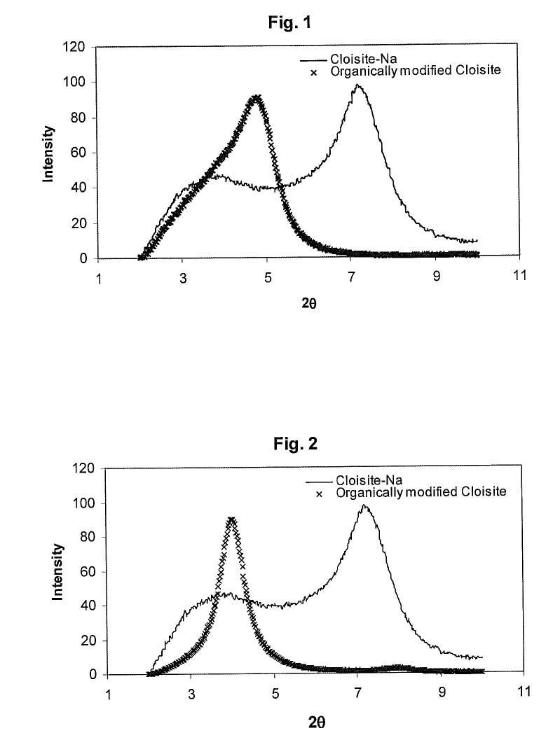

(a) The unmodified clay, CLOISITE-Na⁺ was slowly poured into the mixing beaker of water. The mixture was stirred for 10 min to 24 hrs and placed in an ultrasonic bath for an additional ten minutes to 2 hours to ensure the clay particles were well dispersed. To this, 0.5200 g of benzyldimethylhexadecylammonium chloride and 0.03955 g of 2,2′-azobis(2-methylpropionamidine)dihydrochloride (T_{1/2} 1 hr=74° C. and T_{1/2} 10 hr=56° C.) were added simultaneously in 90:10 molar ratio. Prior to addition, the benzyldimethylhexadecylammonium chloride and 2,2′-azobis(2-methylpropionamidine)dihydrochloride were dissolved in distilled water. The amounts of benzyldimethylhexadecylammonium chloride and 2,2′-azobis(2-methylpropionamidine)dihydrochloride added were based on reaching 100% of the cation exchange capacity of CLOISITE-Na⁺ (i.e., 92.6 meq/100 g). The resulting mixture was then stirred for 0.1 to 24 hrs by an overhead stirrer. After stirring, phase separation of the aqueous solution and the hydrophobic clay component occurred. The clay was separated from the aqueous solution by filtration. Excess surfactant was removed by washing the clay with de-ionized/distilled water until no further surfactant could be detected by titration of the washings. To remove absorbed water, the clay was left to dry in a fumehood for several days, then vacuum dried for 12-48 hrs. The modified clay was ground with stainless steel balls in a WIG L BUG ball mill. A ball to clay mass ratio of approximately 5:1 g was used to grind the clay. The mill rheostat was set to 60° C. After 90 minutes of ball milling, the clay was sifted (sonic sifter, purchased from VWR) to a particle size of less than 20 μm. FIG. 1 shows an XRD pattern of the clay made with benzyldimethylhexadecylammonium chloride and 2,2′-azobis(2-methylpropionamidine)dihydrochloride compared to an XRD pattern for commercially available CLOISITE-Na⁺.

(b) Carried out as in (a) except that the 2,2′-azobis(2-methylpropionamidine)dihydrochloride was added to the unmodified clay before addition of benzyldi-methylhexadecylammonium chloride.

(c) Carried out as in (a) except that cetyltrimethyl ammonium bromide (0.4783 g) instead of benzyldimethylhexadecylammonium chloride was added simultaneously with 2,2′-azobis(2-methylpropion-amidine)dihydrochloride.

(d) Carried out as in (c) except that 2,2′-azobis(2-methylpropionamidine)dihydrochloride was added to the unmodified clay before the addition of cetyltrimethyl ammonium bromide (0.4783 g).

(e) Carried out as in (a) except that hexadecylpyridinium bromide (0.5045 g) instead of benzyldimethylhexadecylammonium chloride was added simultaneously with 2,2′-azobis (2-methylpropion-amidine) dihydrochloride.

(f) Carried out as in (e) except that 2,2′-azobis(2-methylpropionamidine)dihydrochloride was added to the unmodified clay before the addition of hexade-cylpyridinium bromide (0.5045 g).

(g) Carried out as in (a) except that hexadecyl-tributylphosphonium bromide (0.6664 g) instead of benzyldimethylhexadecylammonium chloride, was added simultaneously with 2,2′-azobis(2-methylpropion-amidine)dihydrochloride. FIG. 2 shows an XRD pattern of clay made with hexadecyltributylphosphonium bromide and 2,2′-azobis(2-methylpropionamidine)dihydrochloride as well as the XRD pattern for commercially available CLOISITE-Na⁺.

(h) Carried out as in (g) except that 2,2′-azobis(2-methylpropionamidine) dihydrochloride was added to the unmodified clay before the addition of hexadecyltributylphosphonium bromide (0.6664 g).

### Example 2a

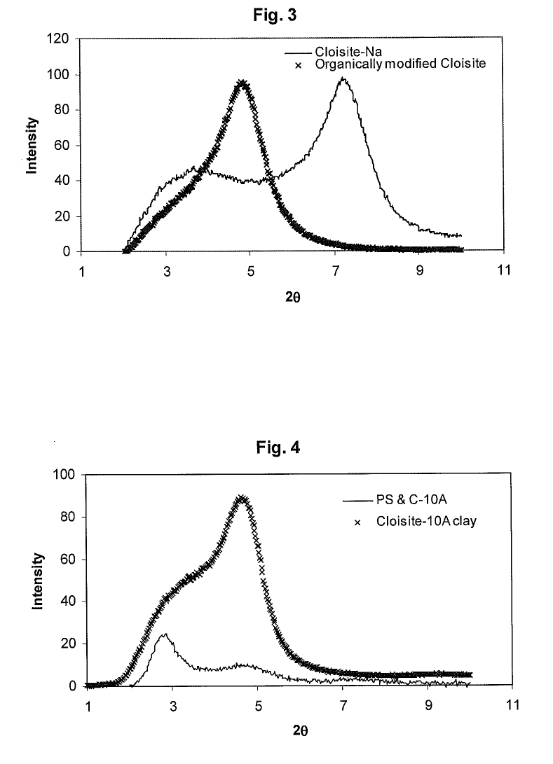

Modified clay which further contains sodium dodecylbenzene sulfonate (0.0987 g) as an anionic compound was made as above in Example 1(a), except that sodium dodecylbenzene sulfonate was added before the addition of the benzyldimethylhexadecyl-ammonium chloride and 2,2′-azobis(2-methylpropion-amidine)dihydrochloride. 2,2′-azobis(2-methylpropionamidine)dihydrochloride and benzyldimethylhexa-decylammonium chloride and were added simultaneously or sequentially. The sodium dodecylbenzene sulfonate was added to the clay dispersion as a solution in water. FIG. 3 shows an XRD pattern of clay modified with sodium dodecylbenzene sulfonate, benzyldimethylhexa-decylammonium chloride and 2,2′-azobis(2-methylpropion-amidine)dihydrochloride as well as an XRD pattern for commercially available CLOISITE-Na⁺.

### Example 2b

Modified clay which further contains sodium dodecylbenzene sulfonate as an anionic compound was made as above in Example 1(c), except that sodium dodecylbenzene sulfonate was added before the addition of the cetyltrimethylammonium bromide and 2,2′-azobis-(2-methylpropionamidine)dihydrochloride. 2,2′-azobis-(2-methylpropionamidine)dihydrochloride and cetyltri-methylammonium bromide were added simultaneously or sequentially.

### Bulk Polymerization of Styrene at a Single Temperature

### Example 3 Comparative Example

CLOISITE-10A®, 0.3283 g (“CLOISITE-10A” is a natural montmorillonite clay which has been modified with a quaternary ammonium cation, and is available from Southern Clay Products) was added to styrene (19.5 g). The clay material was fully dispersed at room temperature at 1 wt % (of inorganic content) in styrene monomer using mechanical agitation and sonication. Next, benzoyl peroxide (0.1209 g) initiator was added to the monomer mixture-clay system at room temperature under mechanical agitation. Polymerization was carried out to 50% conversion under 90° C. isothermal conditions in a 5 ml pressure rated stainless steel micro-reactor. Residual monomer was stripped off under vacuum at 80° C. over 96 hours. FIG. 4 shows an XRD pattern of both the CLOISITE-10A material and the resulting polystyrene clay nanocomposite.

### Example 4

The modified clay (0.2736 g) prepared in Example 1(a) [i.e., clay modified with benzyldimethylhexadecylammonium chloride and 2,2′-azobis(2-methylpropionamidine)dihydrochloride] was added to 19.5 g of styrene. The modified clay was fully dispersed at room temperature at 1 wt % (inorganic content) in styrene monomer using mechanical agitation and sonication. Next, 0.1209 g of benzoyl peroxide initiator was added to the monomer-clay system at room temperature using mechanical agitation. Polymerization was carried out to 50% conversion under 90° C. isothermal conditions in 5 ml pressure rated stainless steel micro-reactors. Residual monomer was stripped of under vacuum at 80° C. over 96 hours. FIG. 5, shows the XRD pattern of the modified clay and the resulting nanocomposite. By comparing FIGS. 4 and 5, a person skilled in the art will recognize that clay exfoliation is superior when using a both a cationic surfactant and a free radical initiator to modify the clay (Example 4) relative to use of clay modified only with a cationic surfactant (Example 3).

### Bulk Polymerization of Styrene at Two Temperatures

### Example 5

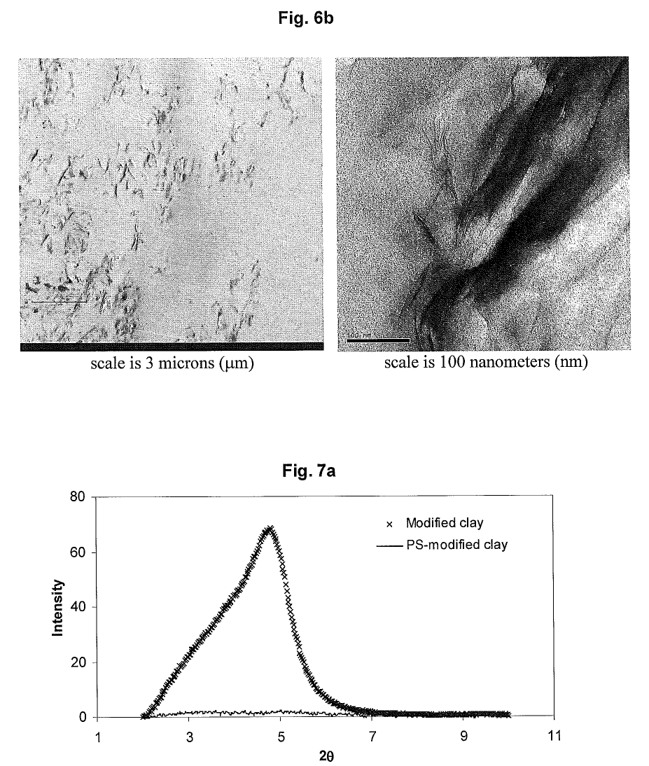

In this example, 0.3283 g of CLOISITE-10A clay was added to 19.5 g of styrene. The modified clay was fully dispersed at room temperature at 1 wt % (inorganic content) in styrene monomer using mechanical agitation and sonication. Next, 0.0727 g of t-butyl peroxybenzoate initiator (T_{1/2} 10 hr=104° C. and T_{1/2} 1 hr=125° C.) was dissolved within the monomer-clay system at room temperature using mechanical agitation. The temperature was first increased from RT to the half-life temperature, T_{1/2} =74° C., of 2,2′-azobis(2-methylpropionamidine)dihydrochloride (T_{1/2} 1 hr=74° C. and T_{1/2} 10 hr=56° C.) for 1 to 24 hrs and then increased to the half-life temperature, T_{1/2} =125° C. of the t-butyl peroxybenzoate initiator (T_{1/2} 1 hr=125° C. and T_{1/2} 10 hr=104° C.) for a time period long enough to achieve a targeted amount of solids. Polymerization conducted in 5 ml pressure rated stainless steel micro-reactors. The resulting nanocomposite was then devolatilized (residual monomer was stripped of under vacuum at 80° C. over 96 hours), extruded and pelletized. FIG. 6a shows the XRD pattern for isolated nanocomposite as well as for the CLOISITE-10A material. FIG. 6b shows the TEM of the nanocomposite at two different magnifications.

### Example 6

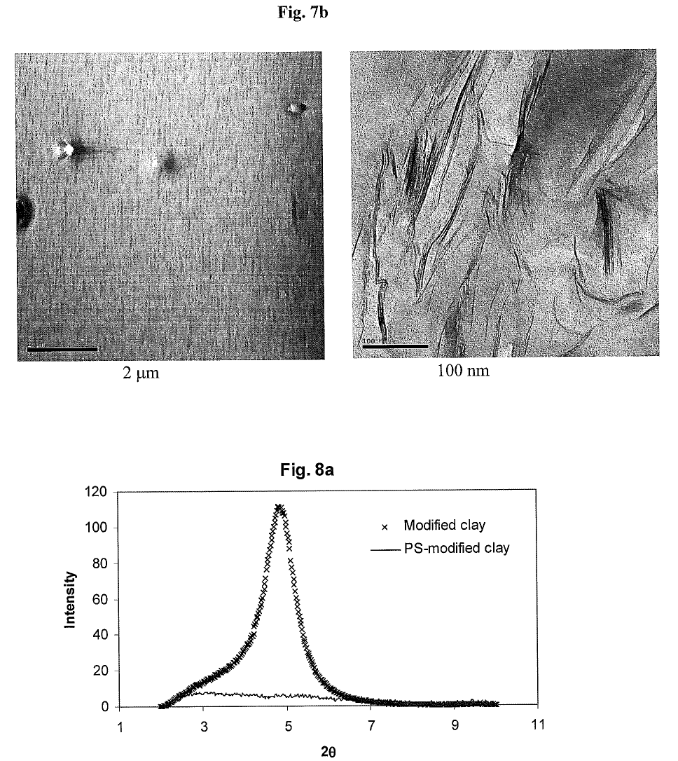

0.2736 g of the modified clay prepared in Example (1a) [i.e., clay modified with benzyldimethylhexadecylammonium chloride and 2,2′-azobis(2-methylpropionamidine)dihydrochloride] was added to 19.5 g of styrene. The modified clay was fully dispersed at room temperature at 1 wt % (inorganic content) in styrene monomer using mechanical agitation and sonication. Next, 0.0727 g of t-butyl peroxybenzoate initiator (T_{1/2} 10 hr=104° C. and T_{1/2} 1 hr=125° C.) was dissolved within the monomer-clay system at room temperature using mechanical agitation. The temperature was first increased from RT to the half-life temperature, T_{1/2} =74° C., of 2,2′-azobis(2-methylpropionamidine)dihydrochloride (T_{1/2} 1 hr=74° C. and T_{1/2} 10 hr=56° C.) for 1 to 24 hrs. The temperature was then increased to the half-life temperature, T_{1/2} =125° C. of the t-butyl peroxybenzoate initiator (T_{1/2} 10 hr=104° C. and T_{1/2} 1 hr=125° C.) for a time period long enough to achieve a targeted amount of solids. Polymerization was conducted in 5 ml pressure rated stainless steel micro-reactors. The resulting nanocomposite was then devolatilized (residual monomer was stripped of under vacuum at 80° C. over 96 hours), extruded and pelletized. FIG. 7a shows the XRD pattern of the modified clay and the resulting polymer-clay nanocomposite. FIG. 7b shows TEM data for the nanocomposite at two magnifications.

The data shows that the nanocomposite has substantially exfoliated clay. By comparing FIGS. 6a to 7a and 6b to 7b, a person skilled in the art will recognize that clay exfoliation is superior when using a two stage bulk polymerization process employing a clay modified with both a cationic surfactant and a cationic free radical initiator (Example 6) relative to using a clay that is modified with only a cationic surfactant (Example 5).

Table 1 shows some physical parameters for the polymer nanocomposite prepared according to Example 6, as well as for a comparative polystyrene resin (high heat crystal polystyrene PS1600, NOVA Chemicals). Flexural modulus and flexural strength are determined according to ASTM D790, Tensile Modulus according to ASTM D638, Melt Flow according to ASTM D1238, and IZOD impact strength according to ASTM D256.

TABLE 1

| | Inventive | Comparative |
|---|---|---|
| Physical Property | Nanocomposite | Polystyrene Resin |
| Flexural modulus | 5.61 | 4.766 |
| (E+05 psi) | | |
| Flexural stress | 13290 | 14620 |
| (psi) | | |
| Tensile Modulus | 5.811 | 4.859 |
| (E+05 psi) | | |
| IZOD Impact test | 0.35 | 0.40 |
| (ft.lb/inch) | | |
| Melt Flow (g/mol) | 3.18 | 5.5 |
| Tg (° C.) | 106.7 | 100 |

The data in Table 1, clearly show that the nanocomposite of the current invention has superior flexural modulus (18% improvement) and tensile modulus (20% improvement) when compared to a commercially available polystyrene.

### Suspension Polymerization at a Single Temperature

### Example 7

Polyvinylalcohol (0.8 g) was dissolved in de-ionized water (1250 g) followed by the addition of 120 g of a 20 wt % solution of poly(diallyldimethyl-ammonium chloride). Separately, 1.34 g of clay (CLOISITE-Na⁺) that had been modified with sodium laurylsulfate and cetyltrimethylammonium chloride was added to styrene monomer (99 g). The modified clay was fully dispersed at room temperature at 1 wt % (inorganic content) in the styrene monomer using mechanical agitation and sonication. Benzoyl peroxide (0.62 g; T_{1/2} 1 hr=92° C.; T_{1/2} 10 hr=73° C.) was added to the styrene monomer/clay mixture, which was then added to the water phase and the resulting mixture was mechanically stirred at room temperature to form droplets. The temperature was ramped up to 90° C. and polymerization was carried out for 8 hours in a temperature controlled jacketed glass reactor.

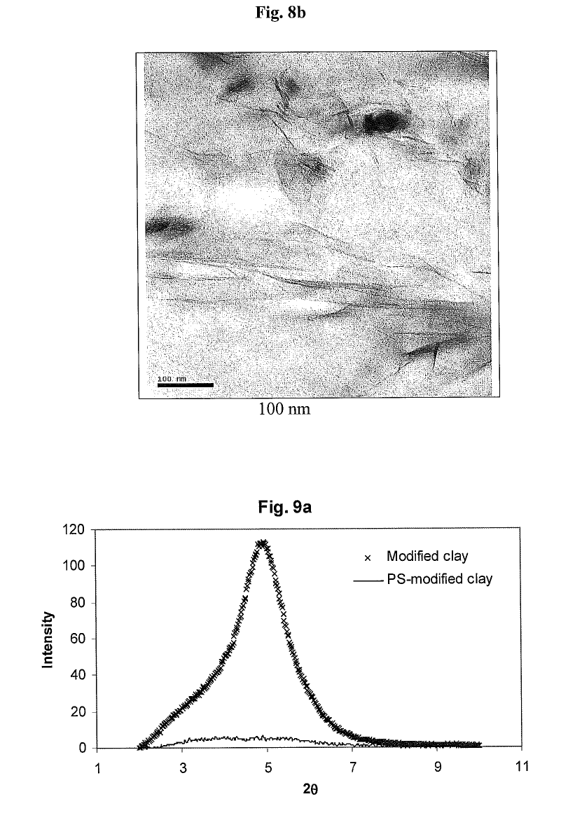

FIG. 8a shows the XRD pattern of the modified clay and the resulting polymer-clay nanocomposite. FIG. 8b shows the TEM of the resulting nanocomposite. The data show that a nanocomposite having substantially exfoliated clay can be made with a suspension polymerization process when a clay which has been modified with a cationic surfactant and an anionic compound is employed.

### Suspension Polymerization at Two Temperatures

### Example 8

Polyvinylalcohol (0.8 g) was dissolved in de-ionized water (1250 g) followed by the addition of 120 g of a 20 wt % solution of poly(diallyldimethyl-ammonium chloride). Separately, 1.25 g of clay (CLOISITE-Na⁺) that had been modified with cetyltri-methylammonium chloride, 2,2′-azobis(2-methylpropionamidine)dihydrochloride and sodium dodecylbenzene-sulfonate was added to styrene monomer (99 g). The modified clay was fully dispersed at room temperature at 1 wt % (inorganic content) in the styrene monomer using mechanical agitation and sonication. Benzoyl peroxide initiator (0.62 g; T_{1/2} 1 hr=92° C.; T_{1/2} 10 hr=73° C.) was added to the styrene monomer/clay mixture. The resulting mixture was then added to the water phase and the entire mixture was mechanically stirred at room temperature to form droplets. The temperature was initially increased from RT to 70° C., which approximates the half-life temperature, T_{1/2} 1 hr=74° C., of 2,2′-azobis(2-methylpropionamidine)dihydrochloride (T_{1/2} 1 hr=74° C. and T_{1/2} 10 hr=56° C.) for 1 to 24 hrs. Next, the temperature was increased to 90° C. for a time period which was long enough to provide a targeted amount of solids and residual monomer levels. The polymerization reaction was carried out in a temperature controlled jacketed glass reactor.

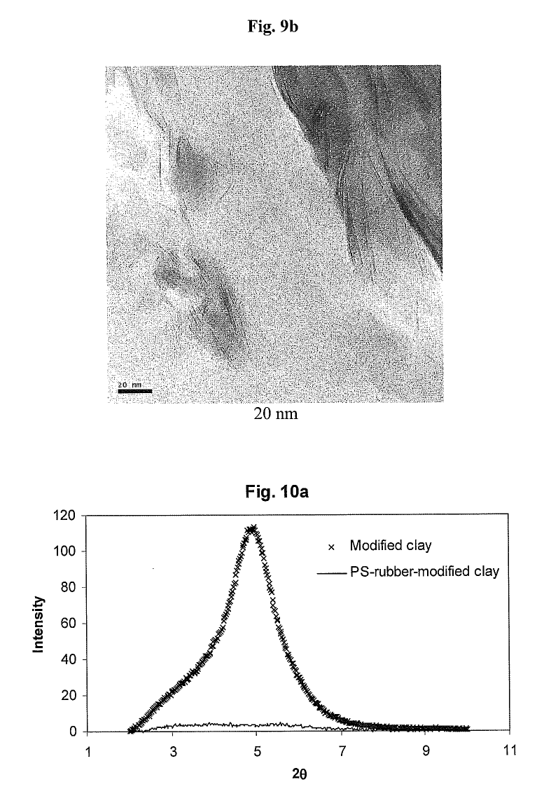

FIG. 9a shows the XRD pattern for the modified clay and the resulting polymer-clay nanocomposite. FIG. 9b shows the TEM of the polymer-clay nanocomposite. The data shows that the two stage suspension polymerization process, which employs a clay that has been modified with a cationic surfactant, a cationic free radical initiator and an anionic compound, provides nanocomposite materials having substantially exfoliated clay.

### Suspension Polymerization of Styrene Containing a Dissolved Polymer at Two Temperatures

### Example 9

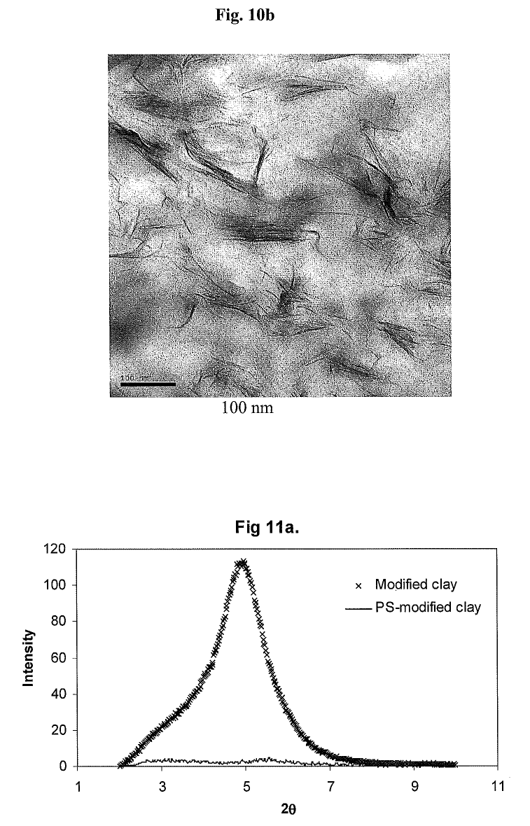

Polyvinylalcohol (0.8 g) was dissolved in de-ionized water (1250 g) followed by the addition of 120 g of a 20 wt % solution of poly(diallyldimethyl-ammonium chloride). Separately, 10 g of polybutadiene rubber (Diene 55AC10, Firestone Polymers) was dissolved in styrene (89 g). Next, 1.25 g of clay (CLOISITE-Na⁺) that had been modified with cetyltrimethylammonium chloride, 2,2′-azobis(2-methylpropionamidine)-dihydrochloride and sodium dodecylbenzenesulfonate was added to the styrene/-polybutadiene mixture. The modified clay was fully dispersed at room temperature at 1 wt % (inorganic content) in the styrene/poly-butadiene mixture using mechanical agitation and sonication. Benzoyl peroxide initiator (0.62 g; T_{1/2} 1 hr=92° C.; T_{1/2} 10 hr=73° C.) was then added to the styrene/polybutadiene mixture/clay system. The resulting mixture was incorporated into the water phase and mechanically stirred at room temperature to form droplets. The temperature was initially increased from RT to 70° C., which approximates the half-life temperature, T_{1/2} 1 hr=74° C., of 2,2′-azobis(2-methylpropionamidine)dihydrochloride (T_{1/2} 1 hr=74° C. and T_{1/2} 10 hr=56° C.) for 1 to 24 hrs. The temperature was then increased to 90° C. for a time period long enough to achieve a targeted amount of solids as well as residual monomer levels. The polymerization reaction was carried out in a temperature controlled jacketed glass reactor. FIG. 10a shows the XRD pattern for the modified clay and the resulting polymer-clay nanocomposite. FIG. 10b shows the TEM of the polymer-clay nanocomposite.

### Example 10

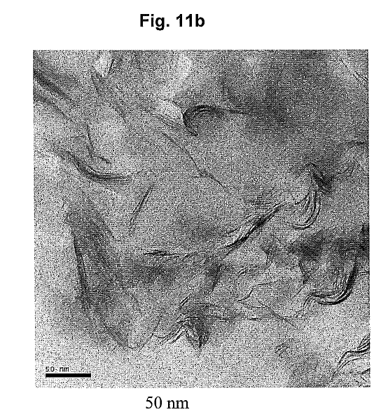

Polyvinylalcohol (0.8 g) was dissolved in de-ionized water (1250 g) followed by the addition of 120 g of a 20 wt % solution of poly(diallyldimethylammonium chloride). Separately, 1.25 g of clay (CLOISITE-Na⁺) that had been modified with cetyltri-methylammonium chloride, 2,2′-azobis(2-methylpropionamidine)dihydrochloride and sodium dodecylbenzene-sulfonate was added to styrene monomer (69 g) containing 30 g of dissolved polystyrene. The modified clay was fully dispersed at room temperature at 1 wt % (inorganic content) in the styrene-polystyrene mixture using mechanical agitation and sonication. Benzoyl peroxide initiator (0.62 g; T_{1/2} 1 hr=92° C.; T_{1/2} 10 hr=73° C.) was added to the styrene-polystyrene mixture/clay system. The resulting mixture was then added to the water phase and the entire mixture was mechanically stirred at room temperature to form droplets. The temperature was initially increased from RT to 70° C., which approximates the half-life temperature, T_{1/2} 1 hr=74° C., of 2,2′-azobis(2-methyl-propionamidine)dihydrochloride (T_{1/2} 1 hr=74° C. and T_{1/2} 10 hr=56° C.) for 1 to 24 hrs. Next, the temperature was increased to 90° C. for a time period which was long enough to provide a targeted amount of solids and residual monomer levels. The polymerization reaction was carried out in a temperature controlled jacketed glass reactor. FIG. 11a shows the XRD pattern for the modified clay and the resulting polymer-clay nanocomposite. FIG. 11b shows the TEM of the polymer-clay nanocomposite.

In view of the foregoing, it is to be understood that the present invention can be practiced in numerous modifications and variations without diverging from the scope of the invention described.

1. A polymerization process to prepare a polymer-clay nanocomposite wherein the process comprises:
a) dispersing in a monomer mixture, a modified clay comprising the reaction product of:
i) a clay,
ii) a cationic surfactant, and
iii) a free radical initiator comprising a positively charged functional group,
to provide a modified clay/monomer mixture dispersion,
b) adding an oil soluble initiator to said modified clay/monomer mixture dispersion,
c) heating said modified clay/monomer mixture dispersion to a first polymerization temperature, wherein said free radical initiator comprising a positively charged functional group is thermally activated, and
d) heating the modified clay/monomer mixture dispersion to a second polymerization temperature, wherein said oil soluble free radical initiator is thermally activated,
wherein said second polymerization temperature is at least 10° C. higher than said first polymerization temperature.

2. The polymerization process according to claim 1, wherein the monomer mixture comprises at least one polymerizable monomer selected from a group consisting of styrene, methylstyrene, tertbutylstyrene and dimethylstyrene.

3. The process according to claim 2, wherein the free radical initiator comprising a positively charged functional group is an azo compound.

4. The polymerization process according to claim 3, wherein the free radical initiator comprising a positively charged functional group, comprises at least one positively charged functional group selected from the group consisting of ammonium ions, sulfonium ions, phosphonium ions, guanidinium ions, amidinium ions, pyridinium ions and imidazolium ions.

5. The polymerization process according to claim 4, wherein the cationic surfactant is provided by a compound selected from the group consisting of quaternary ammonium salts, phosphonium salts, sulfonium salts, pyridinium salts, imidazolium salts and mixtures thereof.

6. The polymerization process according to claim 5, wherein the clay is a smectite clay with a cation exchange capacity of at least 50 milliequivalents, per 100 grams on a 100 percent active basis.

7. The polymerization process according to claim 6, wherein the total amount of cationic surfactant and free radical initiator comprising a positively charged functional group, loaded on to the clay, is from 50% to 200% of the cation exchange capacity of the clay.

8. The polymerization process according to claim 7, wherein the ratio of the cationic surfactant to the free radical initiator comprising a positively charged functional group is from 95:5 to 50:50 mole percent.

9. The polymerization process according to claim 8, wherein the monomer mixture further comprises at least one polymerizable comonomer selected from the group consisting of methacrylic acid, methacrylamide, methyl methacrylate, methyl acrylate, ethyl acrylate, n-propyl acrylate, iso-propyl acrylate, n-butyl acrylate, iso-butyl acrylate, t-butyl acrylate, ethyl methacrylate, n-propyl methacrylate, iso-propyl methacrylate, n-butyl methacrylate, iso-butyl methacrylate, t-butyl methacrylate, and maleic anhydride.

10. The polymerization process according to claim 8, wherein the monomer mixture further comprises at least one dissolved polymer or copolymer component.

11. A polymer-clay nanocomposite formed according to the process of claim 1.

12. A polymerization process to prepare a polymer-clay nanocomposite wherein the process comprises:
a) dispersing in a monomer mixture, a modified clay comprising the reaction product of:
i) a clay,
ii) a cationic surfactant,
iii) a free radical initiator comprising a positively charged functional group and
iv) an anionic compound,
to provide a modified clay/monomer mixture dispersion,
b) dispersing said modified clay/monomer mixture dispersion in water to provide an aqueous dispersion,
c) adding an oil soluble initiator to said modified clay/monomer mixture dispersion or to said aqueous dispersion
d) optionally adding a stabilizer to said aqueous dispersion,
e) heating said aqueous dispersion to a first polymerization temperature, wherein said free radical initiator comprising a positively charged functional group is thermally activated, and
f) heating said aqueous dispersion to a second polymerization temperature, wherein said oil soluble free radical initiator is thermally activated,
wherein said second polymerization temperature is at least 10° C. higher than said first polymerization temperature.

13. The polymerization process according to claim 12, wherein the monomer mixture comprises at least one polymerizable monomer selected from a group consisting of styrene, methylstyrene, tertbutylstyrene and dimethylstyrene.

14. The polymerization process according to claim 13 wherein the free radical initiator comprising a positively charged functional group is an azo compound.

15. The polymerization process according to claim 14, wherein the free radical initiator comprising a positively charged functional group, comprises at least one positively charged functional group selected from the group consisting of ammonium ions, guanidinium ions, amidinium ions, pyridinium ions, sulfonium ions, phosphonium ions and imidazolium ions.

16. The polymerization process according to claim 15, wherein the cationic surfactant is provided by a compound selected from the group consisting of quaternary ammonium salts, phosphonium salts, sulfonium salts, pyridinium salts, imidazolium salts and mixtures thereof.

17. The polymerization process according to claim 16, wherein the anionic compound is selected from the group consisting of sulfonate, sulfate, carboxylate, phosphonate, and phosphate compounds and mixtures thereof.

18. The polymerization process according to claim 17, wherein the clay is a smectite clay with a cation exchange capacity of at least 50 milliequivalents per 100 grams on a 100 percent active basis.

19. The polymerization process according to claim 18, wherein the total amount of cationic surfactant and free radical initiator comprising a positively charged functional group, loaded on to the clay, is from 50% to 200% of the cation exchange capacity of the clay.

20. The polymerization process according to claim 19, wherein the anionic compound is added in amounts sufficient to neutralize the clay edges.

21. The polymerization process according to claim 20, wherein the ratio of the cationic surfactant to the free radical initiator comprising a positively charged functional group is from 95:5 to 50:50 mole percent.

22. The polymerization process according to claim 21, wherein the ratio of anionic compound to the total amount of cationic surfactant and free radical initiator comprising a positively charged functional group is from 1:75 to 1:10 mol percent.

23. The polymerization process according to claim 22, wherein the monomer mixture further comprises at least one dissolved polymer or copolymer component.

24. The polymerization process according to claim 22, wherein the monomer mixture further comprises at least one polymerizable comonomer selected from the group consisting of methyl methacrylate, methyl acrylate, ethyl acrylate, n-propyl acrylate, iso-propyl acrylate, n-butyl acrylate, iso-butyl acrylate, t-butyl acrylate, ethyl methacrylate, n-propyl methacrylate, iso-propyl methacrylate, n-butyl methacrylate, iso-butyl methacrylate, t-butyl methacrylate, maleic anhydride, hydroxyethyl acrylate, hydroxyethyl methacrylate, hydroxypropyl acrylate, hydroxypropyl (meth)acrylate acrylamide, methacrylamide, vinyl propionate, vinyl butyrate, vinyl stearate, isobutoxymethyl acrylamide, and methacrylic acid.

25. A polymer-clay nanocomposite formed according to the process of claim 12.

26. A modified clay, comprising the reaction product of:
a) a clay,
b) a cationic surfactant,
c) a free radical initiator comprising a positively charged functional group, and
d) an anionic compound,
wherein, the modified clay is dispersible in an organic or aqueous mixture.

27-35. (canceled)

36. A modified clay comprising the reaction product of:
a) a smectite clay with a cation exchange capacity of at least 50 milliequivalents per 100 grams on a 100 percent active basis;
b) a cationic surfactant provided by a compound selected from the group consisting of quaternary ammonium salts, phosphonium salts and sulfonium salts, pyridinium salts, imidazolium salts and mixtures thereof;
c) an azo or a peroxide based free radical initiator, which further comprises a positively charged functional group selected from the group consisting of ammonium ions, guanidinium ions, amidinium ions, pyridinium ions, sulfonium ions, phosphonium ions and imidazolium ions; and
d) an anionic compound selected from the group consisting of sulfonate, sulfate, carboxylate, phosphonate, and phosphate compounds and mixtures thereof.

37. A method for preparing a modified clay material comprising the steps of:
a) dispersing a clay in water to provide a dispersion,
b) adding to said dispersion, an anionic compound,
c) adding to said dispersion, a cationic surfactant,
d) adding to said dispersion, an azo or a peroxide based free radical initiator comprising a positively charged functional group, to form a dispersion of modified clay,
e) isolating the modified clay by filtration,
f) optionally washing the modified clay with water,
g) optionally grinding the modified clay to particles sizes that are equal to or less than 20 microns, and
h) optionally sieving the modified clay to particles sizes that are equal to or less than 20 microns.

38-43. (canceled)
